(19) United States
(12) Patent Application Publication
(10) Pub. No.: US 2011/0017529 A1
(43) Pub. Date: Jan. 27, 2011

(54) Truly electric car

(75) Inventor: Edward Gordon Durney, Millbrae, CA (US)

Correspondence Address: PATENT STRATEGIES, 11 ROSALITA LANE, MILLBRAE, CA, 94030, US

(73) Assignee: A Truly Electric Car Company, Millbrae, CA (US)

(21) Appl. No.: 12/509,427

(22) Filed: Jul. 24, 2009

(51) Int. Cl. B60K 1/00

(52) U.S. Cl. 180/65.1

(57) ABSTRACT

Truly electric cars may make other cars obsolete. Not just gasoline cars, but other electric cars. Unlike gasoline cars, truly electric cars can be divided up into modules. Different fuels—gasoline, electricity from batteries, hydrogen—can be used to power the car by replacing a power unit. Car bodies can be updated to conform to changing fashion. Even while keeping the motors that power the car, still good for a million miles. Functions like four-wheel drive and electronic stability control can be done in software, so they can be fixed and upgraded cheaply. Motor controls can be software-based too, and upgraded over the Internet rather than requiring a mechanic's services. With electric motors in a car's wheels, it can beat any gasoline car, going from 0 to 100 miles per hour in 10 seconds, while getting 100 miles per gallon and going 1,000 miles on a tank of gas.

### FIELD OF INVENTION

Electric cars.

### OUTLINE

A. INTRODUCTION: FROM PISTONS TO ELECTRONS
B. TWO BIG PROBLEMS HELPED
   1. Cooling Down Global Warming
   2. Getting Past Gas
C. CHARACTERISTICS OF A TRULY ELECTRIC CAR
   1. An Assembly of “Black Box” Modules
   2. Central Car Operating System
   3. Vehicle-Wide Data and Power Buses
   4. Artificial Intelligence
   5. Can Be Mass Customized
   6. Able to Upgrade (Software and Hardware)
   7. Drive By Wire
   8. Per Wheel Motors
   9. Easy to Operate and Maintain
   10. Styling Freedom for Body and Interior Design
   11. Flexible Fuel
   12. Local (Non-Factory), Modular Assembly
   13. Digital Rather Than Analog Electronics
D. ADVANTAGES OF GASOLINE CARS
   1. Energy Density
   2. Powerful Engines That Travel Far
   3. Inexpensive Cars and Fuels
   4. Technology Continues to Improve
   5. Appealing to Consumers
E. PROBLEMS WITH GASOLINE CARS
   1. Carbon Dioxide Emissions and Pollution
   2. Inefficiency—No Way Around Waste Heat
   3. Limited Types of Fuel
   4. Lots of Ancillary Systems
   5. Bulky, Heavy Engines
F. ADVANTAGES OF ELECTRIC CARS
   1. Zero or Low Pollution
   2. High Efficiency and High Power
   3. Cheap Fuel from Various Fuel Sources
   4. Simple, Easy to Maintain, Reliable
   5. Smaller, Lighter Motors
G. PROBLEMS WITH ELECTRIC CARS
   1. Limited Range
   2. Heavy, Bulky, Expensive Batteries and Cars
   3. Low Power and Efficiency Over Changing Conditions
   4. Problems with Hybrids
   5. Safety and Other Issues of High Voltage and High Current
H. ADVANTAGES OF A TRULY ELECTRIC CAR
   1. New Business Models (and Profits!) Possible
   2. Easier to Manufacture, Test (No “Rust Belt” Car Factories)
   3. Increased Power, Efficiency, Range, Safety
   4. Light, Low Voltage, Low Current, High Power Motors
   5. “True” Four Wheel Drive, Traction Control
I. PROBLEMS WITH A TRULY ELECTRIC CAR
   1. Cost of Car and Cost of Repairs
   2. Complexity
   3. Immature and Disruptive Technology
   4. Reliability and Durability
   5. Safety
J. HOW A TRULY ELECTRIC CAR MIGHT WORK
   1. Car Operating System
      a. Car Operating System
      b. Control and Sensor Inputs
      c. Data and Power Buses
      d. “Drive By Wire” Throttle
   2. Driver Control Unit
   3. Four In-Wheel Motors
      a. Rotor
      b. Stator
      c. Cooling System
   4. Four Motor Controls
      a. Motor Control Hardware
      b. Motor Control Software
      c. Twenty Motor Phase Power Electronics Units
   5. Power Unit
      a. Twenty-One Battery Packs
      b. Adaptive Generator
      c. Diesel Engine
      d. Fuel Tank
      e. Heat for Car Interior
   6. Car Body
      a. Car Exterior
      b. Windows and Doors
      c. Car Interior
      d. Driver and Passenger Communication, Navigation and Entertainment
      e. Heating and Cooling
   7. Car Chassis
      a. “Drive By Wire” Steering
      b. “Drive By Wire” Braking
      c. Fully Active Electronic Suspension
   8. Connections, or Interfaces, Between Modules
      a. Data
      b. Mechanical
      c. Power
K. THE DRAWINGS

### A. INTRODUCTION: FROM PISTONS TO ELECTRONS

A hundred years ago electric cars were the future. Electric cars were clean. Quiet. Powerful. America's most famous scientist (Thomas Edison) and most famous businessman (Henry Ford) teamed up to put electric cars all over the nation's roads.

But the future is here now, and electric cars are not it. Despite all efforts, electric cars have been a flop. (The future, as Yogi Berra said, ain't what it used to be.) Over 99% of the cars on our roads today run by controlled explosions under the hood. Internal combustion rules the road. The Pistons—not the Electrons—play basketball in Detroit.

All kinds of people have tried to make electric cars work. They still try. They still fail. That's puzzling. Why do electric cars fail? More importantly, will electric cars finally succeed now? Those are the issues I will look at here.

But let me first put the problem in perspective by looking at another technology—writing.

Writing was done by hand for centuries. (Of course there were printing presses, but they were used differently.) Then 1874 produced the typewriter, with gunmaker E. Remington & Sons making the first commercial model, the “Sholes & Glidden Type Writer.” Typewriters got rid of some of the most dreary, time-consuming office work. And typewriters continued to improve.

Then electrification jolted the writing world. Electric typewriters made typing faster, with near print-like quality. Manuals seemed primitive. The future seemed to lie in carbon ribbons for typing sharp and dark, and in lighter and cheaper electric machines.

Then suddenly, a new technology—word processing—jolted the world of writing again, even more sharply this time. Typewriters (manual and even the most advanced electric) disappeared. With word processors, we now do things with writing impossible even 30 years ago. Typewriters have faded into the past.

Cars may be the same. For centuries, the horse was the ultimate in personal transportation (not mass transportation). Then came the “horseless carriage.” That jolted the world of transportation. Horses disappeared. And cars continued to improve. Now electric cars once again seem set to solve a lot of the problems with gasoline cars.

But I describe here a new concept—truly electric cars. Truly electric cars can, I think, jolt transportation just like word processing did writing. Gasoline cars, and “converted” electric cars, may disappear. The Detroit Pistons may even change their name. We may be able to do things in transportation impossible today.

I think that electric future belongs to truly electric cars. Here I tell why.

To do that, I first look at the characteristics of truly electric cars. Next, I look at some advantages and disadvantages of existing cars—both gasoline and electric—and some advantages and disadvantage of truly electric cars. Finally, I look in detail at how a truly electric car might work.

But first, a suggestion. Patents tend to be boring, or too long, or both. This one may well be both. A lot of detail is here. Some of it will probably not interest you. Feel free to browse and skip around—this patent was designed to be read that way. The above Outline may guide you in doing that.

### B. TWO BIG PROBLEMS HELPED

Two big problems—global warming and oil depletion—loom over our future. Both threaten damage to our environment and our economies. Even, according to some, complete collapse of our society. Our current gasoline cars make both problems worse.

Truly electric cars may help. They make sense for at lot of reasons, offering a path toward rapid innovation and better performance at lower cost. But the advantages don't stop there. A truly electric car might be our best bet to help solve these two big problems—to cool down global warming and to get past gas. Let's look at how.

1. Cooling Down Global Warming

Our climate is changing. It always has been changing, and it always will be changing. Over the past 100 years the worldwide average temperature has gone up. As has the concentration of carbon dioxide in the atmosphere.

Many think that the latter has caused, or at least contributed to, the former. By burning carbon-based fuels like oil and coal, we cause carbon dioxide in the air to increase. If that is causing global warming, for the first time man—not nature—may be causing the climate over the whole earth to change.

If more carbon dioxide causes the earth to warm, we are in trouble. Big trouble. Because we burn more and more natural gas, gasoline and coal every year. Carbon dioxide makes up only a tiny bit of the atmosphere. But in the last 100 years that bit has gone from 0.028% to 0.038%. That's an almost 35% increase.

Despite the Kyoto Accords and other efforts, carbon dioxide's rate of increase is not slowing. It's accelerating. If the rate of increase holds up, or gets faster, we may see a concentration of more than 0.056% by 2050—double the share of carbon dioxide in the air before we started pumping it in by the millions of tons.

That worries people. Cars and “light trucks” (pickup trucks, minivans and sports utility vehicles) pose a particular problem. In the United States, those vehicles account for almost 30% of the carbon dioxide that we put into the air.

Catalytic converters control pollutants—carbon monoxide, hydrocarbons and nitrogen oxides—coming from our cars. Not carbon dioxide. We have nothing to control the carbon dioxide our cars put out. That makes the carbon dioxide load from cars and light trucks awfully hard to reduce or eliminate.

Except for truly electric cars. These cars can break the strong link between cars and carbon, and between oil and our transportation. The power unit in these cars can get the needed electricity from gasoline, batteries, a combination of the two, hydrogen fuel cells, or a variety of other fuels.

If the electricity to power a truly electric car comes from batteries charged by nuclear, hydro, wind or solar power, little if any carbon dioxide is created. True zero-emission vehicles—with even carbon dioxide emissions being zero—become possible.

Even when gasoline is used on board the car to generate electrical power, truly electric cars can help reduce carbon dioxide. The efficiency of truly electric cars means that we might put out less than 25% of the carbon dioxide a gasoline car puts out to cover the same distance. That's a big difference.

Do we need to cut down on carbon? Most climate scientists think so. They believe strongly that we must reduce carbon dioxide levels rapidly and drastically. But some do not. Global warming is a difficult issue. As Niels Bohr said (and Yogi Berra and others repeated), “predictions are hard to make, especially about the future.”

With truly electric cars, as the future becomes the present, we can see the future unfold and adjust to it. These cars break the link between oil and cars. We then have a choice of fuels. That flexibility, coupled with the efficiency of truly electric cars, may make a big difference in dealing with global warming.

2. Getting Past Gas

Do you ever feel selfish when you fill up your car with gas?

It takes a hundred million years to make a barrel of oil. When the oil's gone, it's gone. Many alive today may see oil become too precious to burn. As supplies wane, we may go to war over oil. (Some think we already have.)

Peak oil looms not far ahead. As spiking gasoline prices in 2008 told us, oil supplies have limits. At the beginning, the earth probably had about three trillion barrels of oil. We've already burned a trillion barrels—the easiest to get to and the best quality. Already we saw strong demand for oil produce only steady, or even declining, supply.

How bad will it get? And how soon? Hard to tell. A Scientific American article had the title: “How Long Will the Oil Last?” In that article, the author worried that the world's oil could not last more than 40 years, and probably less. That was in 1919.

Lucky for us, the oil did last, much longer than 40 years. But we can't count on our luck continuing. The future for oil looks grim. A quarter of the oil ever consumed was pumped in the last decade. The first trillion barrels took about 125 years to burn. The next trillion looks to take about 35 years. And we are pumping more every year, not less.

Demand comes not just from the United States. The average American can afford to consume the equivalent of nearly 3 gallons of oil products per day. That's because residents of the United States are among the wealthiest people on the planet.

By comparison, the average Pakistani uses just the equivalent of 0.08 gallons of oil per day. Not because that Pakistani doesn't want to use more oil. He or she can't afford to. When incomes rise, demand does too. Increasingly, people in other countries are willing to pay as much for oil as Americans do. Or more. Prices go up.

Truly electric cars can help. Over 99% of the 800 million cars on the world's roads today are powered at least in part by gasoline, diesel or natural gas. That link between our cars and oil is old and strong, and not easily broken.

The fuel flexibility of truly electric cars, though, can break the link. We can then move to other fuels as oil supplies continue to tighten. Eventually, these cars can wean us off oil completely. Get us past gas for good.

A truly electric car will soften the impact of our cars on the world. Maybe by four or five times. Even if such a car burns fossil fuels, it does it that much more efficiently. And it can use other fuels—almost any kind of fuel imaginable. That will help with peak oil, and with global warming.

So maybe we can leave our children and grandchildren with hope that they can live their own lives well. Not leave them an earth pocked with dry oil wells and scorched with heat. Truly electric cars may change a grim future to bright.

### C. SOME CHARACTERISTICS OF A TRULY ELECTRIC CAR

In this section I explain broadly what a truly electric car might be. That is important, for to me the truly electric car differs from the gasoline car as much as the gasoline car differs from the horse and buggy.

What makes a car “truly electric”? Designed to be electric, it's an assembly of “black box” modules. Not an integrated machine, like today's cars (both gasoline and electric) have to be. And not merely a gasoline car converted to be electric. That mere change in concept—from seeing the car as an integrated, mechanical machine to seeing it as an assembly of independent, self-contained modules—makes a world of difference.

To avoid any doubt, though, I want to stress one thing. This is a patent. In a patent, the discussion does not define the invention. The claims do. The discussion is intended to help interpret the claims, not to limit them. If I say here that my invention is one thing, and the claims say it is something else, go by the claims. The claims govern.

With that in mind, let me describe my concept of a truly electric car. I do that by outlining some characteristics that, ideally, a truly electric car might have. These ideal characteristics may include the following (as shown in FIG. 6). You can still have a truly electric car without having all of these characteristics. In fact, some of them might not, in some cases, be worth the trouble.

Note that here I talk about characteristics, not advantages. I will talk about advantages later.

1. An Assembly of “Black Box” Modules

Each major function of a truly electric car is performed by a “black box” module. Making the car means the fairly simple task of assembling the modules. Each module can have its own modules, and on down to individual components. Think of a personal computer, and its modules. The same “mix and match” architecture applies.

Modular, “mix and match” systems make up a truly electric car. These systems are made to standard specifications, so they can be installed on any car. In engineering terms, that means that the systems of a truly electric car are distributed and independent. Not integrated as they are in a gasoline car. Each system is a “black box” that operates with other systems only as defined in a standard specification.

2. Central Car Operating System

In a truly electric car, a central car operating system—a software program—controls the car. The car operating system starts the car's systems and oversees its operation. The car operating system is software, not a mechanical or hardware system. (Of course the software needs to run on hardware, so there is hardware involved.)

A truly electric car gives total electric and electronic control of the car. The central software will be complex, controlling the car like an operating system controls a computer. But being software, one car operating system might be used on all the cars in the world Like Windows or Linux work on almost all computers, one common car operating system might work on almost all cars.

3. Vehicle-Wide Data and Power Buses

A truly electric car has data and power buses (probably multiplexed) that connect the car's systems and components. Many truly electric cars will have several data buses: some complex and fast, some simple and slow. For example, the controls for steering, braking and accelerating can talk—over a data bus—with the wheels and other hardware that actually carry out the steering, stopping and moving.

Power buses may also be needed at different voltages. Some electrical systems may be at 12 volts, while the motors may be at 300 volts. In an ideal electric car, the whole car—including the motors that power it down the road—can run at one voltage, such as 42 volts. But the power buses need to be available throughout the car.

4. Artificial Intelligence

A truly electric car has artificial intelligence that increases efficiency and performance. Car system designers can write software algorithms to do many tasks that are beyond the ability of even the smartest of today's “dumb” gasoline cars.

For example, a truly electric car may have an algorithm that lets it park itself in a garage with tight spaces. The driver can get out of the car, push one button on a remote, and have the car pull in the garage, shut itself off, and close the garage door. Our truly electric cars will do some things better than we can (especially those of us who are not perfect parallel parkers).

5. Can Be Mass Customized

A truly electric car can be customized to fit its owner. Many basic features can be left to the taste (perhaps even changing taste) of the driver. A truly electric car may become so customizable that everyone is driving a “one of a kind” car.

Unlike most products, though, a truly electric car can be custom-made at a mass-production price. With a modular approach, each buyer can choose from among different modules to have their own car built to order. Not at the factory, necessarily, but at a local assembler like a repair shop. Because the modules can be mass-produced, costs remain low even while choice expands.

6. Able to Upgrade (Software and Hardware)

A truly electric car can be upgraded even after purchase. Old modules can be replaced with newer, better modules. Software can be replaced with newer, better versions. New features can be added by adding new software, or hardware, or both. You can also fix bugs or replace obsolete technology.

This approach is old—Alfred Sloan found at General Motors that you can add an endless series of “hang-on” features (later including automatic transmissions, air conditioning, and radios) installed in existing body designs to sustain consumer interest. A truly electric car both expands the old approach and takes it to new levels.

7. Drive By Wire

“Drive by wire” means steering, accelerating and braking a car with electronic, rather than mechanical, controls. No mechanical linkages means the controls can be anything—even a joystick that could be operated from anywhere in the car.

A truly electric car operates by wire, meaning by electronic controls, not by mechanical controls. While this may seem to be a small point, it has big implications. With mechanical controls, the steering wheel typically is the first part to be placed on the chassis, and the integrated car is built around it. Electronic controls let the car be “disintegrated,” or split into independent modules.

8. Per Wheel Motors

A truly electric car has “per wheel” electric motors, meaning that each motor is dedicated to driving a single wheel. The motors may be in-wheel, near-wheel or direct-drive motors. Ideally, a truly electric car has four in-wheel motors, one driving each of the car's four wheels.

An electric car with just one motor driving two wheels through a transmission is still an integrated car. Separating the motor from the other parts of the car remains a tough job, almost like ripping the heart of the car out. Making that kind of car modular does not work well. It's an electric, but not a truly electric car.

9. Easy to Operate and Maintain

A truly electric car is easy to operate and maintain. The car now assists the driver in driving the car. With drive-by-wire systems, the car responds to the driver's commands quickly and smartly. Operating a car becomes as simple as it can be.

Truly electric cars have simple systems, making maintenance easy. Oil changes and oil pressure gauges become obsolete. The electric motors that power the car can, if protected from collisions and damage, last for millions of miles.

(There are tradeoffs. One problem with truly electric cars—and it is indeed a problem—is the amount of important software that runs the car. I will talk about that problem later.)

10. Styling Freedom for Body and Interior Design

With a truly electric car, the body and interior of a car can be designed with complete (or at least much more) freedom. Designers of the body and interior of a gasoline car must make allowance for mechanical linkages between different car systems. Those constraints do not apply to a truly electric car. Designers have much more freedom in designing the car to appeal to buyers than they do with any gasoline car.

11. Flexible Fuel

Electricity powers a truly electric car. But it does not matter where the electricity comes from. It could come from a set of batteries, charged from the electrical grid or from a home solar power system. It could come from an on-board “genset,” made up of a gasoline engine hooked up to a generator. Or it could come from a fuel cell. Or the power unit could start out as one system, and later be changed to another.

A truly electric car is truly flexible as to the fuel that powers it. It's not just that different liquid fuels can be fed to an internal combustion engine.

12. Local (Non-Factory), Modular Assembly

A truly electric car can be assembled locally, in a service station or similarly equipped facility. No factory needed. Assembly consists of putting together modular systems—putting the body on the chassis, attaching the wheels with their motors, plugging cords into the power and communication buses, and the like. This work is specialized and skilled, but nothing a trained mechanic cannot handle.

13. Digital Rather than Analog Electronics

A truly electric car draws on the power of digital electronics.

Analog electronics tend to cost less, be simpler, and be more reliable than digital electronics. But analog electronics have a fatal flaw—they are application specific. Analog electronics have to be hardwired to do a specific task. They cannot practically be improved or upgraded. Instead, they must be replaced.

With the ability to perform a variety of tasks just by replacing the software, digital electronics can make analog look primitive.

### D. ADVANTAGES OF GASOLINE CARS

Virtually every vehicle on the road today is powered by a gasoline or diesel engine. Historically, gasoline cars have provided more power, more convenience, and longer range at a cheaper price than electric cars. That is still true today. Let's look at some of the reasons why gasoline cars continue to rule the world's roads.

1. Energy Density

Why have internal combustion cars dominated the market, with over 99% market share? The main reason lies in the nature of electricity compared to gasoline. Electricity cannot be stored and moved easily. Gasoline can be.

In fact, oil-derived fuels have the best energy density of any fuel we have for cars. Uranium, thorium, plutonium, and similar fuels have better energy density. But they cannot (not yet anyway) provide on-board power for cars.

As a fuel, gasoline is great. Gasoline can be carried around easily in an inexpensive tank. It can be pumped quickly. It can sit around in a car's fuel tank for months without losing any of its power. That makes it ideal as a portable fuel for cars. That's true not just in the United States, but around the world. In every country gasoline has become the fuel of choice.

Numbers tell the tale. A gallon of gasoline holds about 36 kilowatt hours of chemical energy. It weighs about 6 pounds, takes up less than ½ cubic foot, and costs about $3.00 (in June 2009). A nickel metal hydride battery that holds 36 kilowatt hours of electrical energy weighs about a ton, takes up about 10 cubic feet, and costs about $36,000 (in June 2009). The comparison is not really fair—a bit apples and oranges—but it does point out the problem.

That gasoline can, in theory at least, deliver 360 times the energy of an electric battery literally gives gasoline cars energy to burn. And a tank of gasoline can be pumped in less than five minutes. Using a household plug to charge a battery with as much power as a ten-gallon tank of gas would take nine days.

Gasoline's advantages as an energy source make a big difference. Even early on, that was apparent. Gasoline-powered vehicles became essential on the battlefields of World War I. Electric vehicles were worthless there. Before that, gasoline cars ran in the aftermath of the 1906 San Francisco earthquake. Electric cars did not. It's no fluke that today gasoline cars rule the roads.

2. Powerful Engines that Travel Far

In 1895, the Chicago Times-Herald sponsored America's first car race, a 50-mile endurance test. Just two of the six entrants finished. The winner (and the other finisher as well) was powered by an engine using a little-known, dangerous and unstable byproduct of kerosene refining—gasoline.

In the century since, the gasoline engine has proven powerful, reliable, cheap and adaptable. As noted above, gasoline, with its high energy density, gives cars energy to burn. Big engines and powerful transmissions have become cheap and common. In fact, most car industry innovation has focused on adding horsepower to ever smaller, ever cheaper car engines.

Between 1981 and 2003, the average horsepower of cars sold in the United States almost doubled. What was already plenty of power became almost an excess.

We want that power. We need about 15% of the average engine's power for most highway driving, and about 5% for city driving. That's all. Cars have 100 or 200 (or more) horsepower engines for just a few tasks—to quickly accelerate today's big, heavy cars, to pass other cars, and to climb hills. Maximum horsepower may be used 1% of the time. Or even less. But we notice if power is not available when wanted.

All the amenities that consumers want—as well as climbing hills, accelerating from a stop, accelerating to pass, carrying a heavy load of passengers and cargo, and towing boats and trailers—make big power demands. We expect today's gasoline engines to meet those power demands. And they do.

Gasoline engines also give us a big advantage over electric cars: long range. A typical driver wants a range of about 250 miles before needing to refuel. Today's gasoline cars satisfy that with ease. Most cars travel 300 to 500 miles on a tank of gas. Some now have ranges well over that. The 2004 Toyota Prius, for example, promises an average range of 660 miles on one tank of gas.

In most of the United States, gasoline stations are easy to find. Pumping an empty tank full of gas takes less than five minutes, including paying for it. For many people driving gasoline cars, making long trips hour after hour with only a few refueling stops—say for example driving the 750 miles from San Francisco to Salt Lake City in 12 hours—seems a normal thing.

Is long range that important? As electric car advocates point out, most commuters take round trips of 50 miles or less. A range well under 100 miles before recharging would be sufficient for almost all drivers.

But the distance limitation may be important. Even in the earliest days when gasoline stands were rare, car owners wanted a car that was capable of “touring,” though they rarely used them for that purpose. Today, most sports utility vehicle buyers never go off road, but they pay a lot more for a car that provides them that fantasy.

So carmakers still see a role, and perhaps the leading role, for the internal combustion engine for years to come. A Ford executive's comments a few years ago (2002) still reflects the view of most carmakers: “While we likely will see some alternatives, Ford believes the internal combustion engine will continue to be the major element in the foreseeable future.”

3. Inexpensive Cars and Fuel

The cost of a car heavily influences consumers. And the cost of the car's propulsion system heavily influences the car's cost. Gasoline cars win on cost.

Why? Gasoline cars are cheaper to make than electric cars. The problem is the power source. One auto executive pointed out that: “It's not hard to see that we can build an electric car that's as cheap, or maybe even slightly cheaper than our current gasoline cars. But it's very hard to see how I'm going to take a battery and have it compete in cost with a $50 fuel tank. The bottom line on cost is the battery.” In addition to expensive batteries, most electric cars need other expensive things to keep weight low, reduce air resistance, and increase range.

Today, 12 major carmakers split up the global car market. They sell big numbers of “me too,” look-alike cars, so economies of scale help reduce costs. Carmakers compete mainly on cost, and that drives cost down. So gasoline cars cost much less than electric cars, whose numbers are small and economies of scale not available.

Today (in 2009) the cost of gasoline is hard to predict. Most American drivers, though, keep a close eye on the price at the gasoline pumps. In just a few years, we have seen gasoline prices go from historic lows, when adjusted for inflation, to historic highs, then back down. Yet in spite of complaints about high prices, most Americans continue to buy more and more gasoline each year, not less.

Cheap gasoline cannot last forever. But gasoline prices in the United States have remained rather stable for decades. The cost of gasoline at the pump does not reflect all economic costs in getting the gasoline there. Subsidies, tax breaks, even the costs of military action in the Persian Gulf, might fairly be considered part of the cost of gasoline.

Even so, in June 2009 the retail price of a gallon of gasoline (less taxes) was about $3 in the United States. That price covered oil exploration, drilling, extraction, transportation of crude oil, refining, transportation of gasoline, and the retailer's margin. Bottled water often costs more to buy. Given the energy contained in that gallon of gasoline, that price is difficult to beat.

Today, gasoline can be purchased readily almost anywhere in the world. Some say wars have been fought to secure oil. Exploration, extraction techniques, supertankers, refining of gasoline from oil, and tanks and trucks for hauling gasoline have all been the focus of immense investment. That all pays off for today's drivers.

4. Technology Continues to Improve

Gasoline cars continue to improve. Worldwide, the major carmakers spend billions on developing new technology. Daimler, for example, gets around 2,000 patents a year, spending around $18 million a day on research and development. Some say carmakers spends more on research and development than any other industry.

One method being researched even for gasoline cars is brake-energy regeneration. Whenever the driver applies the brakes, or just takes his or her foot off the accelerator, the car's alternator converts the car's kinetic energy into electric energy and feeds it into the battery. Stored in this way, the energy can be re-used instead of being wasted.

Car pollution has eased. Under government pressure, carmakers have greatly reduced pollution from gasoline cars. Gasoline cars are over 90% cleaner than they were in the 1960s. In 2001, gasoline engines powered 10 of the 13 “greenest” cars and trucks evaluated by an environmental group. Electric and alternative-fuel vehicles had dominated past winners lists.

Carmakers improve fuel efficiency too. In the mid-1960s, cars averaged 14 miles per gallon, while 1998 models were required by the federal government to average 27.5 miles per gallon. One environmental group says the doubling of fuel economy since the 1960s has saved us from hundreds of millions of tons of air pollutants.

Carmakers are trying to do even more. Honda produced a “Z-LEV” (Zero or Low Emissions Vehicle) version of the Accord's 2.3-liter, four-cylinder engine. Honda claimed that the engine was nearly pollution-free, and so good it can filter smoggy air. “In some high smog areas like Los Angeles, the Z-LEV's tailpipe emissions can be cleaner than the surrounding air,” a Honda representative said.

Gasoline cars can also move to alternative fuels. With some design differences, gasoline cars can run on things like gasoline of various octanes, diesel fuel (including biodiesel), alcohol (methanol or ethanol), natural gas, and hydrogen gas.

Electricity powers more in gasoline cars every year. From the earliest days, gasoline cars used electricity for the spark to ignite gasoline in the car's engine. Electricity's role increased when dry-cell or lead-acid batteries began to power lights. Then in 1912, Charles Kettering added an electric starter motor to the mix, building an all-electric starting, ignition and lighting system for a new Cadillac.

With more and more electrification, gasoline cars now depend on electricity almost as much as power from the gasoline engine. Most cars continue to move by gasoline power, but electricity powers more and more of the car's other functions. Electricity also provides more propulsion than in the past.

The “electrification” of the gasoline car shows up in many ways. By 1998, the average car had 35 microcomputers. By 2010, over 60 microcomputers are expected. Thirty years ago a typical car peaked at 500 watts of electrical power. Today's cars need 2 kilowatts of power. According to Visteon, in 10 years even gasoline cars will need to deliver up to almost 10 kilowatts of electrical power. A good 90% of all new innovations in cars are met with electronics.

Electrification of the gasoline car reached new levels with the Toyota and Honda hybrid cars of the late 1990s and early 2000s. For the first time, a large number of production cars have an electric motor in the drive train. And Toyota once announced its plan to have an electric motor in the drive train of all of its cars by 2012. At heart, though, they are still gasoline cars.

So the gasoline car, while perhaps not changing in its fundamentals, has not missed out on high-tech improvement. Gasoline cars improve year after year. The rate of improvement seems, if anything, to be increasing.

5. Appealing to Consumers

“The automobile is the idol of the modern age . . . . The man who owns a motorcar gets for himself, besides the Joys of Touring, the adulation of the walking crowd. And the daring driver of a racing machine that bounds and rushes and disappears in the perspective in a thunder of explosions is a god to the women.” So said George Dupuy in The Conquering Automobile, published in April 1906.

I might not say it quite the same way today that George Dupuy did back then. But cars still have a key role in our society, not just as transportation, but as status symbols, the signs we give people of our money and success. Today, just as much as 100 years ago, cars and sex go together.

Consumers, in the United States at least, have shown a strong appetite for cars with the power, range and amenities of modern gasoline cars. Sports utility vehicles, despite high prices and low fuel economy, sell well in the United States. They are popular because they are big, powerful, comfortable cars that look good to most people.

Smaller, cheaper cars with higher fuel economy—whether gasoline or electric—do sell. But carmakers need to meet increased consumer expectations. Basic transportation is not what the market is buying. The status, luxury and comfort provided by cars are key sales points for consumers in the developed countries.

Gasoline cars have set the standard for what consumers expect from cars in terms of things like style, convenience, roominess, power, range, fuel cost, and car cost. Gasoline cars have earned their market over more than a century of competition.

Expensive, small, cramped, slow and stodgy electric cars with limited range and few amenities have proven one thing: “green” consciousness and conserving natural resources are sales points that appeal to only a small fraction of the consuming public.

### E. PROBLEMS WITH GASOLINE CARS

Even with the progress gasoline cars have made, the cost, lifetime and reliability of gasoline cars are all being squeezed. The gasoline engine is not at a technical standstill. But improvements inch along at high costs for small gains. Expensive, complicated new technology must be developed every year to appeal to drivers and passengers, to reduce pollution, and to increase mileage.

From the mass of social and technical constraints surrounding the gasoline car—inefficiency, scarce oil, vulnerability of oil supplies from overseas, cost of gasoline, concerns about air quality, carbon dioxide emissions, and perhaps others yet unknown—competition to the gasoline car from new technologies will inevitably increase.

1. Carbon Dioxide Emissions and Pollution

Burning gasoline puts out carbon dioxide, a so-called “greenhouse gas.” Other pollutants can be filtered out by catalytic converters. Not carbon dioxide. Any combustion will produce it, and it cannot (with today's technology at least) be removed from the exhaust stream. As concerns about global warming rise, that makes internal combustion engines a big problem, with no easy solution.

Some debate whether the climate is warming from increased carbon dioxide or not. Or whether, with 1998 still (by 2009) having the highest recorded average global temperature, the earth is now warming at all. That may not matter. Pressure on governments to tackle global warming is building anyway. That poses a serious challenge to the car industry.

Other pollution—noise pollution and air pollution—are also problems. Gasoline engines are noisy. Anyone in a city or suburb hears gasoline engines all day long—in cars, trucks, buses, scooters, lawn mowers and leaf blowers. Particularly on crowded urban streets or busy interstate highways, the noise of gasoline engines can be deafening.

A bigger problem than noise—gasoline cars are dirty. Even modern cars with complex emissions controls spew out pollutants until their catalytic converter warms up. So carmakers may need to make electric heaters for catalytic converters. The electric heater will get the catalytic converter up to temperature quickly—important because a converter can reduce nitrogen oxide emissions only when it is hot.

At their worst, gasoline engines can be fiercely foul. A two-stroke gasoline engine on a scooter reportedly puts as many unburned hydrocarbons into the air in one day of driving as a modern gasoline car puts into the air over 100,000 miles. Cities in China, Indonesia, Malaysia, Thailand and India saw their air become smoke because of large numbers of two-stroke mopeds on the roads. Some have banned them completely.

With a billion cars, trucks, scooters, motorcycles and buses on the road, the earth's air suffers.

2. Inefficiency—No Way Around Waste Heat

Gasoline cars are inefficient. Less than 20%, or sometimes less than 10%, of the energy in the car's gasoline actually moves the car. The second law of thermodynamics taxes away over 60% of the energy as waste heat. Transmission and other losses bleed away the rest.

Things are not getting any better. Internal combustion engines have become much more powerful over the years. Even so, today's sport utility vehicles are less fuel efficient at an average 16 miles per gallon than the Model T Ford. It went 25 miles on a gallon almost a century ago.

Even worse, fuel efficiency in the United States is going down, not up. American cars and light trucks get worse mileage today than a few decades ago. Almost 26 miles per gallon in 1987 fell to 21 miles per gallon in 2008. Why? The horsepower of the car's engine has doubled on average in the last 20 years. Although rarely called upon, we want lots of power under the hood.

What's the problem? Mainly, it's physics. Internal combustion engines are heat engines. The Carnot cycle gives strict limits to the efficiency for the fuel-to-work conversion using a heat engine. There is no way around the second law of thermodynamics that underlies the Carnot cycle. That limit is firm.

(Or at least no way that I know of. In an episode of The Simpsons, Homer scolded his daughter when he found that she had made a perpetual motion machine: “Lisa, in this house we obey the laws of thermodynamics.” We all must, reluctantly, obey them too.)

Efficiency of a heat engine depends on the temperature difference between the engine's inside and the outside air. The higher the difference, the higher the efficiency. For a gasoline engine, theoretical thermal efficiency tends to be less than 60%. Actual efficiency is lower, usually much lower at 30%. Diesel engines have higher theoretical thermal efficiency, perhaps as high as 80%. Actual thermal efficiency tends to be less than 40%, although some carmakers claim as high as 60%.

So the waste heat from a gasoline or diesel engine ranges between 40% (at best) to 60% or 70% (at worst). That's a lot of heat. All that waste heat not only fails to convert to power, but the heat has to be dealt with. That creates its own problems. One big aerodynamic drag on the car is the air that flows through the radiator. Since that air flow needs to cool the engine, that drag cannot be eliminated.

Waste heat means gasoline cars get poor fuel efficiency. Carmakers must fight against physics and chemistry to try to improve the distance a car can go on a gallon of gas. Improvement is possible. But difficult. Waste heat makes it so.

3. Limited Types of Fuel

In 1919, Scientific American warned the car industry that only 40 years worth of oil was left. What should carmakers do? “The burden falls upon the engine. It must adapt itself to less volatile fuel, and it must be made to burn the fuel with less waste . . . . Automotive engineers must turn their thoughts away from questions of speed and weight . . . and comfort and endurance, to avert what . . . will turn out to be a calamity, seriously disorganizing an indispensable system of transportation.”

People are saying the same thing today. “We are addicted to oil,” former President George W. Bush said in 2006. Sparingly used at first, oil later became a way of life, and now dominates many industries. Use became addiction. Oil allowed the world (the West at least) to climb out of the agricultural age, and large companies to rise to riches. But our “addiction” to oil has caused pollution, global warming, war between nations, and misery. In spite of this, we cannot stop.

One person wisely said that civilization will not soon run out of energy, or even just out of oil. But we may run out of environment. Our environment is losing the capacity to absorb energy's impacts. Our heavy dependence on oil causes problems in our environment, our economy, and our politics, as we extract, transport, burn, and fight over oil. Substitutes for oil are even worse.

Gasoline-powered cars received a boost when enormous amounts of oil shot out of a well in Beaumont, Texas in 1901. The discovery came at a time when the demand for oil products was in severe decline, as gas and electricity displaced kerosene for lighting. Gasoline-powered cars were still a novelty.

But the advantages of gasoline as an energy-rich, easily portable fuel quickly made gasoline cars popular. Gasoline-powered cars now consume half the world's oil and emit a quarter of its carbon dioxide. In the United States, fuel economy stagnates while new-car registrations remain high and the number of miles the average motorist drives each year rises. (Or not, as 2008 was down over 2007's number.)

Even if we stopped buying new cars right now, there are already a billion cars on the world's roads. That's a huge number. Parked bumper to bumper, those cars would circle the earth 100 times. Almost every one of them has an internal combustion engine.

China is leading a Third World rush to “modernize” with private cars. Over 400 million new Chinese drivers may start to drive gasoline cars over the next 50 years. That number, together with big numbers in India and other countries also trying to modernize, will put great pressure on the world's oil resources. To say nothing of the air pollution that will come from that many cars.

Most remaining large oil reserves lie in a few Middle Eastern countries, making the problem worse. Americans fought our two most recent wars in the Persian Gulf. That highlights the problem.

Some experts also say that the scarcity problem is worse than it appears. Many countries' oil reserves have been exaggerated for political and economic reasons. Even deep-welled Saudi Arabia may have less oil than it claims.

The end of the oil era is a real possibility. Many think that the supply of oil has peaked—that is, that we will have less and less oil available even as demand continues to increase. With our thirsty gasoline cars, what will we do then?

4. Lots of Ancillary Systems

In their early days, gasoline cars were loud, smoke-belching brutes whose cranks could snap up and knock a man senseless. Besides, they had gasoline stored in tanks right under a driver's seat. “You can't get people to sit on an explosion,” observed Colonel Albert Pope, the largest maker of electric cars in the late 1890s. Compared to electric cars, gasoline cars were complicated, prone to breakdowns, dirty and dangerous.

Even today, a gasoline car requires lots of regular maintenance, tasks from changing oil and oil filters to replacing timing belts. Repairs tend to be frequent and costly. The typical gasoline car owner visits a mechanic or other service facility at least once a year, and often more. Repairs typically take more than one day.

The maintenance and repair often required for gasoline cars during their lifetime include the following:
Engine fuel sensors, air sensors, and other engine sensors needing replacement/repair
Engine tune ups; fuel injection system repairs
Oil changes and flushes; oil filter replacement
Air filter replacement
Muffler replacement; exhaust system repair (less common with new models)
Radiator fills and flushes; radiator leaks
Fuel pump replacement
Engine head gasket replacement
Water pump replacement
Transmission flush and repairs
Brake pad replacement; brake system repair
Timing and other belt replacements
Hose replacements
Smog tests
Scheduled maintenance every 15,000 miles (with major maintenance at 30,000 and 60,000 miles)
   All this maintenance requires a great deal of money and time.

Any car must have a body, chassis, passenger compartment, steering mechanism and other “user interfaces,” wheel and tires, and doors and windows. Everyone knows that. But gasoline cars also have many other complex, expensive, heavy, and troublesome systems just to move and control the car.
Driver Control System: Steering wheel, steering linkage, brake pedal, master cylinder, brake lines, accelerator pedal.
Steering System: Steering linkages, rack and pinion, tied rods, steering arms, power steering.
Braking System: Brake cylinders, calipers, disks, antilock braking system, computer.
Engine: Engine block, pistons, piston rings, cylinders, cylinder head, gaskets, crankshaft, connecting rods.
Cooling System: Radiator, hoses, fan, fan belts, water pump, thermostat.
Fuel System: Gas tank, carburetor or fuel injector, filter, fuel lines.
Air Intake System: Air cleaner (optional turbocharger, supercharger, intercooler).
Valve Train System: Valves, camshaft, timing belt.
Lubrication System: Oil pan, oil pump, oil filter.
Electrical System: Battery, alternator, voltage regulator.
Ignition System: Distributor, ignition wires, spark plugs, coil, timing belt.
Starting System: Electric starter motor, starter solenoid, battery, alternator.
Transmission and Drive Train: Gearbox and clutch assembly or automatic transmission, universal joints, drive shaft, differential.
Exhaust System: Manifold, muffler, tailpipe.
Emission Control System: Catalytic converter, PCV valve, sensors, computer.

Having a car built around an internal combustion engine, which at the height of its spinning speed might contain 100 explosions a second, requires a lot of ancillary systems. The engine and its ancillary systems are temperamental—they require a lot of maintenance. Much less than they did in past years, granted. But all these temperamental divas—as much as we rely on them—will never be as reliable as electrical propulsion. They can't be. It's not in their nature.

5. Bulky, Heavy Engines

A gasoline engine harnesses the power from controlled explosions of a highly volatile and high-energy fuel: gasoline. Changing the energy in gasoline to rotary power at a car's wheels is a complex, inefficient process. The pressure generated by these explosions puts great mechanical stress on the engine block and the pistons.

Temperatures soar. In fact, temperatures in the combustion chamber of an engine can reach 4,500° F. (2,500° C.). Much of the energy in gasoline changes to heat rather than rotary power. Not only does this waste heat result in low fuel efficiency, but these high temperatures themselves pose a big problem.

Extreme pressures and temperatures in a gasoline engine mean the engine block must be big and heavy. An engine block should be a solid block to contain high pressures. But it cannot be—it has to have holes where coolant can circulate. Cooling the area around the cylinders is critical. As are the areas around the valves. Almost all of the space inside the cylinder head around the valves that is not needed for structure is filled with coolant.

To provide a strong enough structure to contain high pressures, withstand high temperatures, and still provide internal holes for cylinders and coolant, engine blocks have been big, heavy pieces of steel. Bulk and weight also provide rigidity needed to reduce noise and vibration from an engine block.

Attempts have been made to use aluminum alloys, metal matrix composites, ceramic matrix composites, and solid ceramics such as silicon carbide to make all or parts of engine blocks, with some success. Improvements have been made, and are still possible. But the physics and chemistry of internal combustion put strict limits on the size, weight, and material strength needed for a gasoline engine.

Diesel engines? Even worse.

### F. ADVANTAGES OF ELECTRIC CARS

Given the benefits of electricity as the driving force of a car—the efficiency, reliability, simplicity, quiet and cleanliness of electric motors—an electric car with an all-electric drive train seems the future of the car.

The advantages of electric cars have been known for a century. As Scientific American observed in 1896, “The electric automobile . . . has the great advantage of being silent, free from odor, simple in construction, capable of ready control, and having a considerable range of speed.”

That prompted one commentator to note, again in Scientific American, 100 years later in 1996 that “it seems certain that electric-drive technology will supplant internal-combustion engines—perhaps not quickly, uniformly, nor entirely—but inevitably. The question is when, in what form and how to manage the transition.”

Electric cars have been around as long as gasoline cars. Lately they have seen a resurgence. Cars like General Motors' EV1 and Tesla Motors' Roadster provide many advantages over gasoline cars. Some of the advantages of electric cars are set out below.

1. Zero or Low Pollution

Electric vehicles will not completely solve pollution problems. Early fuel-cell cars may well run on fossil fuels. Parallel and some serial hybrid cars will burn them (though they will do it more efficiently). As critics point out, even “emission-free” battery-powered vehicles rely on electricity from power plants that often burn oil or coal.

Still, electric cars will make a big difference. Battery electric cars will produce no emissions from the car at least. In traffic jams or waiting for stoplights, even many hybrid electric cars do not use power or produce emissions. That alone offers a huge advantage on the crowded freeways of Los Angeles and other major world cities.

Power for a battery electric car still has to come from somewhere. But centralizing power production in large electric plants rather than in small gasoline engines reduces air pollution and increases fuel efficiency. Fumes can be dispersed from a tall stack or chimney rather than released near pedestrians. Or treated before release.

As an added bonus, the electricity might come from tidal, solar, wind, or hydroelectric power. Much easier on the environment. No carbon dioxide then, at all.

All things considered, electric cars will dramatically reduce air pollution. The reduction of noise pollution from electric cars may be even more dramatic. In electric cars where no part moves faster than the wheels, the car can move with virtually no noise. Only the noise of the tires on the road and some flexing of the body of the car will be heard, even as speed and power increase.

For many who first drive an electric car, its simple silence leaves the greatest impression. Were electric cars to gain a large percentage of the traffic on urban streets, the silence may be deafening. We worry about air pollution, but noise pollution has also become a great problem for modern societies. Electric cars can help.

2. High Efficiency and High Power

Electric motors have the potential to be much more efficient than gasoline cars. Unlike heat engines, electric motors do not have to give off lots of waste heat to do work. Some heat losses do occur. But they can often be kept to less than 10%. Far from the 60%-plus tax that the ghost of Carnot demands.

In fact, electric cars tend to be three to four times as efficient as gasoline cars. The United States government estimated that less than 20% of the chemical energy in gasoline gets converted into useful work at the wheels of a gasoline car. But 80% or more of the energy from a battery reaches the wheels of a battery electric car.

In addition to higher operating efficiency, electric cars can use regenerative braking. Regenerative braking could recover up to 20% of the energy used in the Federal Urban Driving Cycle.

That big efficiency advantage has already been put to use by Honda and Toyota with their gasoline/electric parallel hybrid cars, which offer 40 to 60 miles to the gallon compared to the 20 to 30 for a comparable gasoline car. That is double the efficiency. A battery-only or series-hybrid electric car with only electric motors in the drive train should do even better.

With this high efficiency, the governments in Japan, Europe, the United States, Canada, and many other countries have encouraged research and development of electric cars. Some governments provide tax incentives for consumers to buy electric cars and other vehicles. The power of the oil and carmaker lobbies in the United States cannot be ignored. But electric cars do tend to draw political support.

That has started to make a difference. For many years, major carmakers focused only on gasoline engines. Slowly, though, the technology for merging electric and gasoline vehicles started to rise, with on-board computers, new materials, and new ideas.

Electric motors are efficient. But they are also powerful. Electric motors can provide power at almost any engine speed. Gasoline engines must rev up for maximum power. Electric motors provide nearly peak power even at low speeds. This gives electric vehicles fast acceleration from a standing stop. Peak performance gasoline engines cannot match.

The Tesla Roadster, accelerating on the flat from 0 to 60 miles per hour in less than 4 seconds, proves that point. As does the Wrightspeed X1 electric racer, said to be even faster.

3. Cheap Fuel from Various Fuel Sources

Running cars on electricity opens up new fuel options not based on oil. That includes renewable resources like wind power and solar energy. Indeed, one big advantage of electric cars over gasoline cars is the variety of power sources to run an electric car. FIG. 5 shows this.

These range from the impractical (in 1894 one inventor proposed using the energy contained in stretched rubber bands) to the proven (gasoline or natural gas engines coupled with a generator, overhead electric wires, inductive strips embedded in roadways, fuel cells, batteries, flywheels, hydraulic energy storage, and solar cells).

If a car runs on electricity from the local electricity utility, the energy used to charge its batteries will come from different sources in different states. Idaho gets almost all of its electricity (over 90%) from hydropower. But Hawaii gets about 75% of its electricity by burning oil. (Almost none of Hawaii's electricity comes from solar and wind, though Hawaii has ample supplies of both.)

In most states, though, and in most other countries, a variety of fuels are used to produce electricity. In France, most electricity (nearly 80%) comes from nuclear power plants. In Denmark, wind produces about 20% of Denmark's electrical power (although the fact that the wind does not always blow makes wind power tough economically—Denmark's wind power usually goes to Norway, sold at a loss).

Electricity does not occur naturally. Some other form of energy needs to be converted to it. We have learned to use many different forms of energy—oil, natural gas, uranium, dammed water, sunlight, wind, and most importantly coal—to make electricity. As cars become electric, that diversity of fuel supply helps.

Many predict that fuel cells will replace gasoline as the preferred power source for cars within the next 20 to 30 years. A fuel cell car, though, is an electric car. If fuel cells do become common in cars, those fuel cell cars will be powered by electric motors. The success of those fuel cell cars may well depend on how well their electric motors power them.

Electricity does not come cheap. But for cars, it can be dramatically cheaper than gasoline. That is because electricity can be converted into motion much more efficiently than gasoline can. Even in California, with its expensive electricity, a battery-electric car will need only about 3 cents of electricity per mile. Gasoline costs more.

Electricity can be cheaper still. Most battery electric car recharging can be done at night, at lower rates. Power companies have lots of underutilized capacity at night. The United States Department of Energy thinks there is enough unused capacity to charge 180 million electric vehicles at night, with no new power plants. Using this capacity would mean lower electricity prices, higher utility profits, or both.

Of course, electricity prices may go up if lots of electric cars start to be charged at night, or at charging stations away from home. Turmoil in the California electricity market due to deregulation—the main cause in the ousting of California governor Gray Davis in 2002—showed how sensitive electricity prices can be to social and political changes. But given the efficiency of electric motors compared to gasoline engines, a real, and big, difference in fuel prices should persist.

And it is not hard to see how using an electric motor in a parallel hybrid like the Toyota Prius and the hybrid Honda Civic have lowered fuel costs. In both cases, the fuel cost per mile has been cut by about 50%.

4. Simple, Easy to Maintain, Reliable

The 2006 movie “Who Killed the Electric Car?” showed how electric cars need little maintenance—no oil changes, filters, or many other common replaceable parts. In the movie, a former mechanic at General Motors said that all he ever did to maintain General Motors' EV1s was rotate the tires and fill the washer fluid. But he showed a table full of all the parts that mechanics regularly replace in gasoline cars.

Electric cars still require maintenance and repairs. But with much simpler systems—and only one moving part in an electric motor—the wear and tear that comes from explosive combustion are eliminated. In particular, the tribological (friction and wear), mechanical, chemical and thermal stresses so difficult to deal with in gasoline engines are much less in an electric motor drive.

We cannot yet compare maintenance of electric cars to gasoline cars. Not enough electric cars are on the road. Some of the few studies to date have shown that battery-electric cars need more maintenance and more frequent repairs than gasoline cars. Those repairs also took more time than for gasoline cars.

But that is probably wrong. While nothing can be taken for granted, high-powered electric motors have been used in high-speed trains, electric buses, subways, and other vehicles for years. Electric motors have proven much more reliable and easy to maintain than gasoline or other internal combustion engines.

In addition, most major carmakers have some parallel hybrid cars in production. Toyota's Prius generally requires little maintenance for its electric drive system, and by 2008 some of those cars had been on the roads for more than seven years. Based on this experience, most experts predict that, apart from battery replacement, no regular maintenance will be required for the power train and related systems of an electric car. That means no oil changes; no 15,000, 30,000 and 60,000-mile service; and no tune-ups.

In addition, the complex engine system and subsystems of a gasoline car simply are not needed in an electric car. Many of the auto parts that a typical car owner is familiar with needing to replace are simply missing in an electric car.

Electric cars will certainly have problems and need to be repaired. Just like gasoline cars, in some cases accidents will damage the propulsion system. In other cases an electric car will stop running due to a failure and will need to be fixed. But there seems to be no question—eliminating the powerful gasoline engine in a car solves many maintenance and repair problems.

5. Smaller, Lighter Motors

Modern cheap (relatively at least), high-strength permanent magnets and good cooling methods have given us low-cost, lightweight electric motors that work well for cars. Both AC and “brushless DC” motors can be small and powerful, designed just for electric propulsion. Those motors make electric cars practical.

Power to motor weight ratios for the best-performing gasoline engines exceed the numbers for most electric motors. And while gasoline engines require bulky, heavy subsystems to support them, so do electric motors often require bulky, heavy batteries. On balance, though, electric motors beat gasoline engines in needing less overall size and weight to produce power.

Many electric cars have one big electric motor that powers the wheels through a transmission. But the natural rotary motion of an electric motor matches nicely with the natural rotary motion of a wheel. That gives a simple elegance to fitting an electric motor directly into the wheel of a vehicle. This is not a new idea—Ferdinand Porsche designed electric cars in 1900 and 1902 using in-wheel, or “hub,” electric motors.

Modern electric motors are small and light enough to fit in wheels. Electric vehicles driven by in-wheel motors have better compactness, higher efficiency, better traction control, weight and space savings, quiet operation and simple driveline. Many of the advantages of in-wheel motors also apply to near-wheel and other direct-drive configurations.

Putting an electric motor in or near the wheel in a car saves a lot of weight and space. The motor itself usually now sits in a space that was not previously used. That opens up the under-hood area for other uses. Electric motors also weigh less than the gasoline engines they replace.

With wheel motors, there is no need for power transmission devices (transmission, drive shaft, universal joints and transfer case) between the motor and the wheels. Many other vehicle systems can be eliminated, made smaller, or repackaged. For example, systems like antilock brakes, traction control, power steering and all-wheel drive can be consolidated or made redundant. Getting rid of those devices saves weight and space.

Finally, the ability to locate systems (apart from the in-wheel motors) anywhere in the vehicle gives flexibility in locating important masses to improve weight distribution. That provides improved crash zone design possibilities, more choices in locating passengers and luggage, and a more comfortable and roomy interior (by lowering the floor, for example).

### G. PROBLEMS WITH ELECTRIC CARS

“The electric car is the future of transportation.” This statement is as true today as it was when it was made, in 1899. Electric cars are naturally clean, quiet, and most of all, efficient. But even today, they remain the cars of the future, not the cars of now. Why have electric cars never fulfilled their promise? Why is almost every car on the road today powered by an internal combustion engine?

The market has proven time and again that electric cars which do not offer the same or better performance at the same or lower cost will not wean us away from our gasoline cars. That creates, therefore, the strong need for an electric car that is better than a gasoline car. We don't have that kind of electric car now. Here are some reasons why not.

1. Limited Range

In the early days of the car, the electric car's range—few went more than 50 miles on a charge—grew more annoying as roads began to extend from the cities and touring became the new American adventure. Spare cans of fuel could be stowed aboard a gas car, and they could go anywhere. But electrics were too fragile for dirt roads, there was nowhere to plug them in, and recharging took a whole day.

Still, in 1900 more electric cars were sold in America than gasoline cars. To most people, electrics were the cars of the future—as soon as their range problems were fixed. Thomas Edison thought electric cars would prevail. At the peak of his success in his early fifties, he devoted a decade of his life and most of his money looking for better battery elements than lead and acid. The nickel and iron pairing he found failed in cars (but led to the nickel batteries used widely today).

Even today, because electricity is not easily stored or transported, the major issues electric cars face are range (miles driven on a single charge) and recharge time. Range is complicated by cold or hot weather, hills, and power drains like defrosters and air-conditioners. Recharge time also varies widely.

Electric cars have difficult problems in colder and hotter climates, particularly colder climates. The cold winters of the Northeast and Midwest of the United States and parts of Canada drain power from batteries. There are solutions to the problems caused by severe cold. None are cheap or easy. For example, General Motors only leased its EV1 in California and Arizona, two states where winter temperatures in the big cities rarely drop below freezing.

There is no infrastructure in place to handle electric cars. Charging facilities can be hard to find, both at home and in places where electric cars may be parked. Many cars do not spend the night in a garage. In the United States, less than a fourth of the drivers of gasoline cars park their cars overnight where they can be charged from their home.

Battery technology continues to evolve. Lithium ion batteries appear likely to be the best bet for the near future. The Tesla Roadster uses almost 7,000 lithium ion cells to provide its electrical power, said to be good for 250 miles.

But those who say that battery technology is good enough now to take battery electric cars mainstream have only theory to back them up. Those with practical experience in producing gasoline and hybrid cars with a well-deserved reputation for reliability, like Toyota, have said that battery-electric car just are not ready.

2. Heavy, Bulky, Expensive Batteries and Cars

Battery technology has made big advances lately. We use batteries all the time in our computers, cell phones, and music players.

But the batteries that power a laptop computer for six hours on a cross-country airplane flight will move an electric car barely 100 yards. The batteries in a cell phone will move it a few feet. An iPod music player battery? Just inches. The 1,000 times change in scale—from milliwatt hours for cell phones and music players to kilowatt hours for cars—is a leap that batteries will not make well.

Right now, the weak link in any electric car is the batteries. Batteries have six problems, ones that must often be balanced against each other:
weight
bulk
capacity
charge time
life
cost

Heavy batteries cause big problems. More weight compounds it. With heavy batteries, stronger and heavier structure must support the battery weight and provide crash protection. As a rough rule of thumb, each kilogram of battery weight needs 0.3 kg structural weight to support it. That's a 30% penalty.

On price, batteries force a trade-off—higher up-front costs for longer life cycles and faster recharging times. More expensive nickel metal hydride batteries, for example, can be used in place of lead-acid batteries. The range of the car will double and the batteries will last about three times as long. Cost will also be 10 to 15 times higher.

With battery electric cars, the high cost of batteries keep prices high. The Tesla Roadster, for example, hit the roads in the United States in 2008 at a price, fully loaded, of $109,000. The Lotus Elise, the sports car on which the Tesla Roadster is based, sells for under $40,000.

Prices for advanced batteries like nickel metal hydride and lithium-ion may fall as these batteries improve and become more used. But all battery technologies for cars still cost far more than today's gasoline engines. That's a major drawback to electric cars competing in the mass market. The physics and chemistry of batteries are unkind.

Perhaps no market for electric cars will develop until prices come down. But what if prices do not come down until a market develops? That Catch-22 may leave electric cars limited to the niche market they currently occupy.

3. Low Power and Efficiency Over Changing Conditions

One drawback to electric cars has been a lack of power to accelerate, or to pass. Weight, battery power production rates, and other issues limited many battery electric cars to zero to sixty mile per hour times of 12 to 20 seconds. That's slow enough to make electric cars unattractive to many people.

The Tesla Roadster and other latest generation (in June 2009) electric sports cars show that electric cars can be powerful. The acceleration of these electric cars puts gasoline cars to shame.

But with electrical power, there is no extra power to burn. With gasoline's high energy density, gasoline car designers have never had to face the constraints on power that electric car designers still need to deal with. Those constraints mean that high power comes at a high cost, in terms of both range and money.

Electric motors can be designed to operate very efficiently within a limited range of speeds. Outside of this range, they quickly lose efficiency. So while electric motors can be over 80% efficient in ideal conditions, over the typical varying driving cycle the efficiency of electric motors may fall to less than 50%.

Differences in efficiency between electric motors can be very high. Because compromises are so difficult to avoid, one attempt to make a practical electric propulsion system for a car, U.S. Pat. No. 5,549,172, goes to the extreme of using two motors in the car.

That invention recognizes that no existing motor performs well over the whole range of car operating conditions. So it tries to upgrade overall system performance by combining a highly efficient motor at low speeds with a highly efficient motor at high speeds. The obvious disadvantage is the need for two complete, separate electric motors.

In-wheel motors give many advantages, which would seem to make them popular. But in-wheel motors have not yet made it into any but prototype cars. Existing motor technology cannot easily meet the high performance demands required of in-wheel motors. Several problems arise.

Putting a heavy motor in a wheel of a car increases its unsprung mass. That hurts comfort, handling and road-holding performance. In a conventional drive system (electric or gasoline), the only unsprung mass in the car are the wheels and a small portion of the drive train. With an in-wheel motor system, the motors become part of the car's unsprung mass.

In-wheel motors have other disadvantages. Cost becomes a major factor if motors are used in all four wheels of a car. Four small motors will always cost more than one big one. And induction motors are usually the cheapest, simplest, most powerful, and most reliable electric motors. They are ill-suited for in-wheel motors.

An in-wheel or direct drive motor has to produce high torque to turn the wheel. In that case, motor torque must equal the wheel torque. Not having a range of gears available will make it difficult to get enough torque at all speeds.

For example, pedaling a tricycle—with its direct drive between the pedals and the wheel—up a steep hill is impossible. A human cannot generate enough torque to do that. But a bicycle with 21 gears can be pedaled up even the steepest hills. The same is true with a gasoline car. If it had only one gear, it would be practically useless. Three or four gears, or a variable transmission, are a necessity to perform adequately.

Some, like General Motors with its AUTOnomy concept car, have given up on in-wheel motors for cars, fearing that they will always be too heavy. A normal electric motor hooked up to wheels through a transmission also poses problems. Good power and efficiency over a range of operating conditions can be devilishly hard for electric car designers.

4. Problems with Hybrids

Hybrids have potential. They also have problems. Using a gasoline engine just to generate electricity for an all-electric drive train solves the range problem. But hybrid cars weaken the advantages, and strengthen the disadvantages, of both gasoline engines and electric motors. For example, a gasoline/electric hybrid car will still cause pollution. That makes it ineligible for electric-only zones.

A series hybrid vehicle must have both a gasoline engine and an electric motor on board the car. Most gasoline engine subsystems are still needed. That adds weight, takes up space, and most importantly, adds cost. Juggling the two systems to get a design that matches the advantages of both may be impossible. As may be making the complete vehicle as cheap as a vehicle with only one system.

Another problem with a hybrid car is weight. The car has to carry the weight of the electric motor, the generator, the gasoline engine and the batteries. Not as many batteries are needed as in a battery electric car, so that saves some weight. But a full-size electric motor plus a 40-kilowatt generator can weigh several hundred pounds.

Electric utilities dislike serial hybrids because they do not draw power from the electric grid and thus do not provide any new business. And oil companies are not excited about cars that can get 80 miles to the gallon or more. Finally, engineers often find hybrids conceptually interesting but practically too complex.

Parallel hybrid cars require complex control systems and control algorithms. The gasoline engine must be matched with one or more electric motors as driving conditions change. Not only do you need two separate systems in the same car—a gasoline engine and one or more electric motors—but you must make those two separate systems work together.

Integrating a gasoline engine and electric motors under a single hood creates complex engineering problems. One person who tried to solve those problems, James Worden, was founder and chief executive officer of the electric car conversion company Solectria. He said of parallel hybrid cars: “It sounds simple. Try building one. It's not as easy as people think.”

It is very hard to develop an algorithm that manages a hybrid power train. No company has been able to come up with a formula that beats Toyota's. Ford (it says) developed its own algorithm only to realize it was very similar to the Toyota approach. In order to avoid a lawsuit, Ford says that it decided to purchase a license rather than pursuing a license to Toyota's patent.

Mercedes was stunned to discover that its vaunted F 500 Mind concept car, a diesel-electric hybrid, actually got worse mileage on the highway than a gas-only version. Nissan decided it could not afford the huge investment—perhaps a trillion yen (about $10 billion dollars)—needed to build a parallel hybrid. It threw up its arms and licensed nearly all of Toyota's hybrid technology.

Politically, hybrids are appealing. Technologically, they could be seen as orphans that no one wants to adopt.

5. Safety and Other Issues of High Voltage and High Current

The high voltages required by high-power electric motors present a particular problem with electric cars. Most motor designers use high voltage to get the high power required by electric vehicles.

Low voltages are attractive. The Honda Insight (a small two-seater) has a 144-volt system for its engine assist motor. The Toyota Prius (a five-seater, although quite small) first had a 288-volt system for its motor, then a 273.5-volt, and then its newer models took the voltage up to 500 volts. But these are smaller cars. Electric motors for large SUVs may have to double these voltages to generate the high power required.

These voltages present a significant safety problem. Any voltage above 50 volts can give a potentially fatal electric shock to a human. If there is a low-resistance connection between a person, the electricity source, and the ground, at these voltages enough current may flow through his or her vital organs to cause death.

Even so, many designers use voltages up to 350 volts in cars and up to 500 volts in commercial electric vehicles. Otherwise, high currents must be used. Motor designers are familiar with the disadvantages of using high currents in a motor. The number of turns in a motor's windings is critical to the amount of torque produced. With high current, large gauge wires are required to avoid melting the wires. Making a motor that requires a large number of turns of large gauge wire can be a nightmare.

So high current requires a large and heavy electric motor and heavy wiring, switching and contacts to generate the desired power. Apart from the size and weight issues this brings, the cost and manufacturability of a high current motor are often impracticably high.

For all the reasons discussed above, the controls (including power electronics) for a high-power electric car motor make up a large, complex, heavy, expensive system. The wires, semiconductors and other components must handle high voltages, high currents, or often both. They generate lots of heat, requiring heat sinks and cooling. All of this increases cost and reduces efficiency.

### H. ADVANTAGES OF A TRULY ELECTRIC CAR

Novelist Louis L'Amour's 1980 novel “Lonely on the Mountain” begins with these lines: “There will come a time when you believe everything is finished. That will be the beginning.” Many people (me included) think that we have reached the end for the gasoline car. A century of improvement leaves little room to improve further, even though global warming, the end of oil, and pollution demand it. With the gasoline car, we have wrung the towel.

That brings us back to a new beginning. To starting again with electric cars.

My invention—the truly electric car—provides a car that offers exceptional power, efficiency and range at a competitive cost. With its independent black-box modules, it can now beat other cars—gasoline and electric—in both performance and cost. And in the future, it can provide transportation that we cannot even dream of now. With truly electric cars, the towel has not been wrung dry. It's dripping wet.

1. New Business Models (and Profits!) Possible

A truly electric car can change the car business, and do it dramatically. New business models become possible. New companies can enter carmaking, and current carmakers can focus more on only one part of the business to make more money. The car industry can start to look like the computer industry.

For example, a truly electric car has little mechanical engineering in the power train. Everything needed to power and control the car is electric, and is built in modules—or sub-modules—to standard specifications. So the modules can be made and then plugged together.

That means that a single part—say a heating system—can fit in a carmaker's every model, from sports car to sports utility vehicle, giving economies of scale that Henry Ford never imagined. (Or maybe he did. Ford still holds the record for the most chassis of a single type built in a year. He built over two million Model T chassis in one year, in 1924.) Even if the cost of the electric motors and batteries never drops to the level of a gasoline engine, the car built around it might be cheap enough to offset the greater expense.

Big changes can also happen in the performance parts and accessory segment of the car industry. That segment could explode, changing the economics of carmaking.

Carmakers make a lot of cars—over 60 million a year. They do not make money. (At least the Big Three in Detroit do not. Toyota and some of the other foreign carmakers have done better.) The car business is not easy. The new car market is not growing in the United States, it's shrinking. Competition is intense. A number of problems haunt the industry. Profits have been the victim.

Truly electric cars may change that. The different modules of a truly electric car allow companies with new technologies to grab a piece of the new-car market. These companies can cherry-pick the part of the market where they can make a profit. For the car operating system, software profit margins may be possible.

The total new car market is over $1 trillion a year. With that kind of revenue, even a small profit margin can be a big number. What if carmakers were able to generate the kind of profit percentages that computer industry companies have proven capable of? Investors would take notice. We would see a whole new kind of industry. (For more on this, see my patent application “Re-inventing carmaking.”)

2. Easier to Manufacture, Test (No “Rust Belt” Car Factories)

A truly electric car can be assembled by plugging together components. That means factories can be decentralized. The only factories needed will be making parts, not cars. So no need for Rust Belt factories. The parts can be assembled anywhere in the country.

Instead of a central production plant, there can be regional outposts, responding that much faster to local market fluctuations. That puts into practice (with a vengeance) the “just in time” philosophy of manufacturing—parts arriving as needed, with no inventory pileup. Given how quickly electronics evolve, this approach could be more than convenient; it might be crucial to a producer's survival.

A truly electric car makes “mix and match” components possible. Gasoline cars have to be built around an integrated propulsion system, with the powerful gasoline engine at the center. A truly electric car can be broken down into connected, but more independent, components.

In that sense, gasoline cars resemble mainframe computers, while a truly electric car resembles a distributed network. Just as with mainframe computers, all components of a gasoline car have to be proprietary components assembled by one carmaker to work together. Just as with distributed networks, a truly electric car lets you combine equipment from several different manufacturers.

One can imagine, with a truly electric car, a car dealer putting together a car with components from several manufacturers to meet a customer's order. The wheels with their motors might be made by Honda, a gasoline engine/generator/gas tank module made by Ford, a “user interface” combining steering, braking and accelerating controls in one joystick made by Nintendo, the chassis made by Magna, and so on.

In addition to these “mix and match” assembly possibilities, car owners could also upgrade their cars by simply upgrading one or a few modules at a time, without replacing the entire car. Here again, this may resemble the personal computer.

Just as the hard disk could be upgraded in a personal computer, the wheel motors might be upgraded in a truly electric car. With the “mix and match” possibilities of a truly electric car, upgrading can be done efficiently, replacing only part of the car and getting a “new” car at much less expense and waste.

3. Increased Power, Efficiency, Range, Safety

Today's cars, while very advanced, waste a lot of energy—only about 1% of a car's fuel energy moves the driver. To do the math, most of the fuel's energy, over 60%, comes out as waste heat in the exhaust and cooling system. About 20 to 25% gets lost in the drive train and in powering odds and ends. That leaves only 15 to 20% of the energy to move the car.

That 15 to 20% needs to fight gravity, inertia, and friction with the air, tires, brakes and road. Of that amount, about 95% moves the car and about 5% moves the driver, given their respective weights. Five percent of 15 to 20% is about 1%. As much as 99% of the fuel goes for naught. A truly electric car can minimize these energy losses, and increase by many times the fraction of the energy that actually moves the driver.

Still, powering a car using an electric motor poses real problems. Operating conditions change constantly. Starting requires high torque at low speed. Cruising requires efficiency. Limits on battery power restrict range. Passing on a highway requires bursts of high torque at high speeds.

Most electric motors operate efficiently only in a narrow range of operating speeds. So an electric motor used in an electric car may be advertised as having a drive train that is over 90% efficient. But that 90% efficiency is for steady cruising over level ground at medium speed, with no starts or stops. The drive train will do much worse—often 50% or less—over the entire driving cycle of a typical car.

A truly electric car with an adaptive control system for its motors, a well-designed motor system, and advanced batteries and central car operating system, may be 90% efficient 90% of the time. That's a big difference.

With the right motor and motor control, a truly electric car can provide peak performance at peak efficiency, all the time. Where the Tesla Roadster currently averages about 4.7 miles per kilowatt hour of electricity, a truly electric car may break 5 miles per kilowatt hour even for a larger car.

High torque also helps. Today's control systems for electric motors cannot actively manage torque well, or influence the torque at design level. That's because choosing a specific type of motor for a particular car largely determines the available torque profile.

The motors I use in my example below, by contrast, provide not only very high torque, but also high starting torque. Special algorithms can increase torque if necessary, and in general I can actively manage torque across the range of operating conditions of the motor.

As technology progresses, efficiency will get better. Increasing efficiency is not easy, even for a truly electric car. But a modular approach lets engineers isolate each efficiency-robbing part of the car, and work on independently improving that part.

By isolating technology like that, technical evolution speeds up. What before evolved in long generations, like a desert tortoise's breeding cycle, now evolves with the speed of a rabbit's breeding, or even a fruit fly. The speed of change increases.

4. Light, Low Voltage, Low Current, High Power Motors

A truly electric car can use the most advanced motor architecture available. An adaptive motor with distributed phases can lower cost by allowing cheaper power electronics to be used. These smaller, lighter motors can be made with light wiring, switches and connectors.

That opens the path to lower cost battery and fuel cell technology. Things like simpler management systems for batteries and fuel cells. Or better packaging options (as smaller systems can fit in more spaces in the car).

This architecture distributes the total current across several “phases,” or electromagnetic circuits, of the motor. That allows the motor to produce high power (like 17 kilowatts) even though the system voltage remains low (42 volts) and the current in each electromagnetic circuit also remains low (under 80 amps).

An adaptive electric motor, with its high torque density, provides more torque per kilogram of weight than existing motors. That may make it possible to use adaptive electric motors as in-wheel motors, or “hub motors,” without adding too much unsprung mass. Or “near wheel” (putting a motor next to, but not in, the wheel). Or other “direct drive” configurations where the motor drives one or more wheels without going through a transmission.

Several other specific problems may come with in-wheel motors. Heating from braking on the motor (made worse by the difficulty of providing effective cooling) may be a problem. A motor in this exposed position may be vulnerable to damage. Cost is also a major factor in deciding if motors can be used in all four wheels.

With all these issues, an adaptive electric motor performs better than existing motors. That may allow a truly electric car to have in-wheel motors. Even where unsprung mass or other factors make in-wheel motors impractical even in a truly electric car, other motor configurations are possible to gain many of the advantages of a truly electric car.

In-wheel adaptive motors solve or reduce many of the problems with existing in-wheel motor systems. The result? In-wheel motors taking up less space, with less weight, more power, more efficiency, greater range, greater traction control, more reliability, better performance. All at a reasonable cost.

5. “True” Four Wheel Drive, Traction Control

One example of a truly electric car has four in-wheel adaptive motors and a central car operating system. Each motor has its own independent controller, power electronics and battery.

This car architecture provides “true” four wheel drive that cannot be matched by any gasoline car. It also provides maneuvering flexibility and traction control that cannot be matched by any other electric car. And if desired, all this can be done solely in software.

Each in-wheel motor can be controlled independently. Control is instantaneous. That gives “true” four wheel drive. Different wheels can even turn in different directions at the same time, something almost impossible in a gasoline car. That gives direct yaw moment control. Movement is possible in two dimensions, right and left in addition to just backwards and forwards

One big advantage that electric motors have over gasoline engines is controllability. No power train for a gasoline engine can practically control fine movement of a wheel, say rotating a quarter turn. By contrast, controlling the rotation of an electric motor at that level, and even much finer levels, is commonplace. You get fast frequency response and low inertia.

Having a car operating system lets a truly electric car be controlled better than a gasoline car. That can make a big difference in safety. A 2006 report from the Insurance Institute for Highway Safety claimed that electronic stability control could prevent 10,000 of the 43,000 fatal car crashes that occur every year. Almost 80% of fatal single-car rollovers could be prevented. A truly electric car takes car control to a higher level than electronic stability control ever could. Safety benefits may exceed even these.

Other advantages? High torque at zero and low wheel speed. Both acceleration and braking the wheel can be done with the motor. Torque can be generated very quickly and accurately, for both accelerating and decelerating. Motor torque becomes easily comprehensible, since little uncertainty exists about the driving or braking torque exerted on a wheel. Wheel motors can be sensors of the driving and braking force between a wheel's tire and the road surface. This will contribute a great deal to road condition estimation and other applications.

With a transmission, differential and other drive line components between a gasoline engine and a car's wheels, the actual torque exerted on the wheel may be hard to determine. Brakes also make actual applied torque hard to determine. Those problems trouble electric cars as well as gasoline cars.

The tight control you get with a truly electric car allows several functions, examples of which are listed below:
Anti-lock braking
Direct traction control
Yaw torque/stability management
Lateral stability
Long brake pad life
Regeneration efficiency
Steering efficiency
Wheel speed information
Thrust performance
Stopping distance
Torque steering/split torque braking
Electrical power consumption
Road condition estimation

Much of this can be done by software. On balance, that means better performance (since upgrading is easy) at a cheaper cost (no manufacturing or installation needed) with greater profit (software's gross margins cannot be beat). Everyone wins.

### I. PROBLEMS WITH A TRULY ELECTRIC CAR

Truly electric cars will be better than gasoline cars in many ways. But there is little magical about truly electric cars. They have their faults as well. Particularly in the beginning, when the technology in them is new, untested and costly. Here are some of the problems to watch for, and try to avoid, with truly electric cars.

1. Cost of Car and Cost of Repairs

Cars started out being only for the rich. Many, if not most, were toys, not true transportation. A 1906 Harper's Weekly article noted: “There are more than 200 persons in New York who have from five to ten cars apiece. John Jacob Astor alone is credited with thirty-two.” Also in 1906, then Princeton-president Woodrow Wilson said: “Nothing has spread socialistic feeling more than the use of the automobile . . . a picture of the arrogance of wealth.”

To start, truly electric cars will cost more than gasoline cars. Carmakers have spent a century driving the cost of making gasoline cars down. They are good at that. While there are gasoline cars that cost a lot of money, most sell for prices that have been sharply honed by competition.

We can see this with electric cars. In 2009, the all-electric Tesla Roadster cost over $109,000. The Fisker Karma plug-in hybrid, set to go on the market in 2010, has been tentatively priced at $80,000. Gasoline cars that compare in features and luxury sell for much less than that.

Batteries are a particular problem. “A lot of the technical problems come back to cost,” one car industry executive said. “You can get better batteries at a cost. You can solve arcing and corrosion by putting in battery disconnect switches and sealed connections at a cost. It's not that we don't know how to do it. It's just that it becomes expensive when you roll all the new technology together into a new vehicle.”

I think a first-generation, four-door, five-passenger truly electric car can make a profit at a sales price of $35,000. Judging by price alone, many people might decide that is not worth the cost. As technology improves and volumes increase, less expensive truly electric cars should become available. But unless some people buy the more expensive, early cars, then technology will not improve and volumes will not increase. A Catch-22 that may be a problem.

Truly electric cars will include some technology than car repair shops are not used to seeing. At least initially, the cost of repairs will probably be high. We should see some benefit, though, from the fewer and simpler systems that truly electric cars will use. Less friction, no transmission, no internal combustion engine at all in many cases. All this will make repairs less frequent.

But some systems, like the in-wheel motors, may be costly to fix when broken. They may be cheaper to replace than repair. The cost of repairs for truly electric cars is hard to predict.

2. Complexity

Even from the early days of the car, complexity has been a problem. No consumer product then compared with the “horseless carriage” in complexity. There were hundreds of different brand names and types of cars. Even the simplest of vehicles could have thousands of parts. Figuring out what car to buy and how to operate and maintain it required a great deal of information. Learning how to fix it demanded, as one writer put it, “a liberal education in itself.”

The motorist's ally in dealing with automotive complexity was the popular press. Specialized publications such as Horseless Age helped car buyers, sellers, owners, operators, repairers, parts suppliers, and even those who just wanted to follow the horseless carriage revolution. More than any invention before or since (except perhaps the computer), the car triggered and became part of an “information revolution.”

Modern cars are even more complex. Even with modern computers and plasma television and digital recorders we buy for our “entertainment centers,” cars may still be the most complex consumer product today. The car industry worldwide says that it spends more on research and development than any other industry.

Truly electric cars bring a lot of new technologies to cars. That is both good and bad. But most of this technology comes from other fields that have spent years evolving—fields like electric motors, motor controls, operating system software, joysticks and other controllers—so they will not necessarily bring a lot of problems with them.

But there will be problems. For example, a truly electric car will typically use distributed architecture. That is, there might be four motors, one in each wheel, with each of five or ten phases in that motor being separately controlled. That distributed architecture may make the car's controller quite complex, more so than a regular motor controller.

Implementing the controller in software can help overcome this disadvantage. The distributed architecture may also require more wiring and other components than traditional designs. In most cases, though, the advantages brought by the distributed architecture greatly outweigh the cost of additional wires and other components.

Thinking about software raises particular qualms about complexity. Modern cars already have a lot of software in them—some have two or three million lines of code. Truly electric cars will have even more code, with some of the most important car functions—braking, steering, stability—entrusted to software.

Our personal computers cannot seem to go very long without crashing. A computer that crashes from software bugs in a car might lead to a real crash, so worries about software complexity should be give close attention.

3. Immature and Disruptive Technology

Technologies like drive-by-wire may not be mature when they hit the market. One example—after appearances in Los Angeles and Las Vegas, the Filo (FEE-low) concept car arrived in Detroit so the car industry could experience drive-by-wire in a functioning prototype. One reporter, after a test drive of the vehicle, said that it would be easy to imagine a driver losing control.

Driving the Filo required considerable concentration because it is so different from a conventional vehicle. The steering was overly sensitive, as the innovative steering yoke had a range of motion of only 20 degrees. It never made a complete turn like a traditional steering wheel. It was also difficult to brake the vehicle with the same hand that had to handle acceleration and changes between two gears by the push of a button.

Illustrating the driving challenges, a guest at a later SKF Filo event in Plymouth, Mich., slammed into a curb with a normal car equipped with the same drive-by-wire technology, causing significant undercarriage damage. (The car, however, was repaired fairly easily and was put back on the road. And no one was injured or died. So lawyers did not have to be called in.)

The road to full drive-by-wire technology may be littered with obstacles. The big carmakers and tier one suppliers agree that technical reliability and regulatory obstacles will need to be overcome. Consumer attitudes will need to change. Otherwise, steering columns and hydraulic brakes will remain in cars.

People, and government regulators, will not settle for immature technology. Before they will get much traction in the car industry, new technologies like drive-by-wire will need to do some quick growing up.

A truly electric car is disruptive. “Disruptive” technology, a term coined by Harvard Business School professor Clayton Christensen, means innovation that promises a big leap in performance, not just incremental advance. And just as a body's immune system will try to reject a newly transplanted heart, industries reject disruptive change. Established market leaders commonly ignore or sarcastically dismiss low-cost and under-powered alternatives to their market leading products. That may happen with truly electric cars.

Standardization is another hurdle. Major carmakers cannot seem to agree on a common communication protocol, thereby diluting the parts development process. Training mechanics and convincing skeptical consumers are still greater obstacles. All this means that, even with its technological edge, a truly electric car may struggle to find acceptance.

Regulations and standards tend to hold back any new movement in the car industry. The movement to truly electric cars is not waiting for some ground-breaking theoretical advance. The technology for each of the basic modules is, for the most part, already tried and tested and being used in a myriad of other technologies.

The problem centers on accepting one universal system that all the manufactures will be happy with. Much like the war that was waged between Beta and VHS for video recording in the 1980s, this is a contest between competing technologies.

Getting the absolute best system is not as important as that we end up with just one system. We need one general architecture for dividing the car into modules. Finding agreement on general system technologies and architectures is now one of the chief missions of the MIT consortium. But they are not having much success. And they are not working on truly electric cars.

The system we eventually see may not be the absolute best. There is always some degree of horse trading when making a giant change in a complex system. But the more the carmakers agree on and set as industry standards, the sooner truly electric cars will drive a change in the way the world moves.

4. Reliability and Durability

Early cars were neither reliable nor durable. Car drivers had to be skilled at do-it-yourself repairs, often done by the side of the road. The popular song “You'll Have to Get Out and Get Under” described one unpleasant aspect of owning a horseless carriage. Before 1910, mechanical breakdowns were an expected part of motoring. As evidence of this, carmakers boasted about the ease with which the crankcases of their cars could be dropped, pistons removed, or engines opened up to remove carbon buildup.

Early cars demanded constant attention. “To keep a machine in a state of perfection,” said one owner in 1908, “one should devote every morning from ten to forty-five minutes to carefully oiling and looking over different parts.” Even with constant care, however, problems occurred. Spark plugs shorted out when the porcelain separated from the metal. Springs broke going over bad bumps. Rubber tires were destroyed by gasoline, sunlight, and sharp stones, making them the Achilles heel of early vehicles.

Early adopters of cars—often doctors who used them to call on their patients—quickly learned to expect trouble. A Dr. Jackson told of one car trip he made in a 1903 magazine Motor World: “Nor did the car give me much trouble. A broken bolt coming over the mountains, two connecting rod breakages and an axle nut dropping off and letting the balls out—this was the sum total.”

Cars have more and more software. In 1996 a typical car had about 50,000 lines of assembly language in its electronic control system. In those days, machine control systems in the range of 2 to 3 million lines of code (usually in the C, C++ or Ada languages) were relatively uncommon. Only traditional high technology industries like defense and aerospace products such as the Boeing 777 or Airbus 340 had them. It took even these industries the best part of 25 years to get to this amount of code.

The car industry has done it in about a third of that time. Today's cars typically have more than a million lines of code, distributed across up to 100 microprocessors. Systems of this size have always presented a major problem in reducing the amount of defects to an acceptable level. The problems simply get much bigger when you grow to this size too quickly.

All that software means bugs, and lots of them. More and more recalls in the car industry come from software defects. Software is now everywhere in a car—airbags, brakes, engine control, climate control, music systems, seats, and navigation all contain substantial amounts. Software problems range from the annoying (an entertainment system that does not work) to the dangerous (brakes that do not work). Whatever the fault, though, carmakers have done so well that we know expect reliable and durable cars. Nothing less will do.

We have already seen one recall for new braking technology. In 2005 Mercedes issued a huge recall of 680,000 Mercedes-Benz SL500 and E-Class vehicles equipped with the new “Sensotronic” electronic brake-by-wire system. The recall applied to SL-Class cars built since October 2001, and E-Class cars built since October 2002. Only about 140,000 of the recalled cars were in the United States. Mercedes recalled the cars on its own initiative as a “precaution” due to a few reported failures of the electronic brake system in unusually high-mileage European taxi applications.

In the few cars that had the problem, the Mercedes fault knocked the brake-by-wire system offline. Fortunately, the backup hydraulic system was still able to stop the vehicle, but without the benefit of power assist. The fix for the Mercedes recall took about an hour, reprogramming the control module with new software. But in some cases hardware was also replaced.

The fallout from this recall put the future of brake-by-wire systems in jeopardy. Mercedes officials announced that it would not be using the brake-by-wire system in any more new vehicle applications. And they took out 600 “needless” electronic features from their vehicles that few people use in an effort to restore their quality and reliability ratings (which have slipped precariously in recent years). Mercedes had been plagued by a string of electronic-related problems that hurt their ranking compared to other luxury brands.

5. Safety

Many may be hesitant to move to truly electric cars because of safety worries. Conventional mechanical systems have stood the test of time and have proven to be reliable. Even on traditional gasoline cars those systems that use software concern us. For example, those of us with airbags are sitting a foot in front of a software-controlled bomb. One bug and the airbag can explode in our face. That gives one pause.

By-wires systems present one safety problem. More than a decade ago, the United States Air Force went through a similar struggle. Mechanical and hydraulic linkages controlling aircraft changed to electrical connection. The now indispensable fly-by-wire overcame much scrutiny at its birth.

And there have been problems, even today. Some new-design stealth military jets flying over the international date line, where the longitude changes abruptly, lost all their navigation systems. They had to follow their tankers by sight over the featureless ocean to a landing zone. Another fault was found before it went into flight—a software bug would have flipped a jet fighter over when it crossed the equator.

An electrical failure could be catastrophic to any by-wire system. In military applications, a failure would be totally unacceptable. Military aircraft must function in some of the most extreme conditions in the world. Failure often means death. Redundant electrical systems were developed, and are now in both military and commercial aircraft over the past decade.

Many believe that the fly-by-wire systems perform better—with fewer faults—than the mechanical systems they replace. And fly-by-wire lets military aircraft do what was impossible. The latest air force aircraft, the F-22 Raptor, is fully fly-by-wire, enabling it to perform maneuvers no other aircraft can do.

By-wire systems are now being incorporated into military land units as well. The Grizzly Tank, an army high-tech ground-assault vehicle, utilizes drive-by-wire. The military has proven that fly-by-wire and drive-by-wire can be not only safe, but highly reliable and effective. But safety is an issue.

Besides drive-by-wire, truly electric cars will use much more electricity than today's cars. Technicians will likely no longer be able to make simple crimp connections. They may want to think twice before haphazardly probing with a standard test light. Working on car power systems could become much more like servicing residential power. We will need procedures for systems lockouts and potentially specific methods for probing a system for bad connections.

We have dealt with some of these issues with Toyota's Prius hybrid cars, some of which have been on the road for ten years. The Prius motor operates at 100s of volts, not 12. That makes a big difference. At 12 volts, arcing is not much of an issue. Not much energy is involved, and an arc quickly collapses. Once you get over 50 volts, though, you can weld with it. And 100s of volts? Very dangerous. We will need to get used to this.

Safety will be an issue with truly electric cars. There will be problems. Count on it. How safety is handled will make a big difference.

### J. HOW A TRULY ELECTRIC CAR MIGHT WORK

Lots of engineering needs to go into making a truly electric car become truly electric. Here I focus on the vision of a truly electric car. As fiction writer Cynthia Ozick said, “The engineering is secondary to the vision.” Those skilled in the art can use their own preferences for the engineering. Here is the vision.

A truly electric car might work as follows. FIG. 2 shows a block diagram of this example. This car has seven modules:
a car operating system
a driver control unit
wheel/motors (four of these)
motor controls (four of these)
power unit
a body
a chassis

The key to the car is connection. Each module will need to connect to other modules in a standard way. In fact, “mix and match” assembly demands standards for connections. Without standards mixed modules will not match. But the module itself can be a “black box”—it can do its own function in its own way. A module can also be made of sub-modules, taking mix and match to a lower level.

A truly electric car can outperform gasoline cars without losing the advantages of electric cars. How good can it be? The example I describe here can do 0 to 100 mph in 10 seconds, get 100 miles per gallon, and go 1,000 miles on a tank. It can hold 5 passengers and has 4 doors. All at an estimated $35,000 price, competitive with gasoline cars. This performance and pricing may overcome social inertia to finally make an electric car a viable, maybe even preferred, car for most consumers.

In rough numbers, the total price of $35,000 might be split up between modules as follows:

| | |
|---|---|
| Car operating system | $3,000 |
| Driver control unit | $1,000 |
| Wheel/motors (set of 4) | $6,000 |
| Motor controls (set of 4) | $2,500 |
| Power Unit | $8,000 |
| Body | $7,000 |
| Chassis | $7,500 |

Once the design is done, I can use contract manufacturing to have these modules made, including the hardware (but not the software) for the car operating system.

With a centralized electronic control system for a car and its propulsion system, one can easily imagine endless future design opportunities. These include centralized traffic control, route programming, cruise control, auto-piloting of a car, accident prevention, recovery of lost and stolen cars, ability to deliver service, repair and upgrades to a car electronically or wireless as-you-go, future software upgrades of a car, and the like.

1. Car Operating System

The car operating system has software and hardware to control the car. Like an operating system on a computer, the car operating system will take input from a “user” (the driver) and make the car do what the user wants. All cars do this in much the same way. So a single car operating system can be designed that will run any truly electric car in the world. Ideally, at least.

a. Car Operating System

The car operating system (hardware and software) forms the car's nervous system. It has a brain (software) that runs the car. For its nerves, it has four data buses.

As its main job, the car operating system controls the six other modules of the car. Its software has to get information from the modules, process the information, and send the right control signals to the other modules to run the car.

For braking, accelerating and steering, the car operating system gets from the driver control unit what the driver wants to do. Then it processes that information to make control signals for the brake, motor and steering systems. By driving those systems, those signals make the car do what the driver wants it to do. FIG. 4 shows the top-level design of one example of the operating system software for the car.

Most modules will also have their own computer systems, running the functions of the module. In some cases, there may be a fuzzy line between what is done in the car operating system and what is done in a module. But almost any task that needs more than one module to work will need to be run by the car operating system.

A car operating system needs its own computer platform to run on, and it must be a nearly “instant on” device. It cannot take five minutes to load a bunch of drivers and the like. It has to be stable, reliable, failsafe and always on (in computer speak, at least five nines—working 99.999% of the time) when the car is in use.

That being said, the car operating system need not run on a supercomputer. Its tasks will be fairly simple, so it can run on a typical microprocessor, much like a laptop computer. It will run as an application program on that computer, so the computer will need an operating system. Linux might work. A custom-designed hardware platform will probably perform best. The tradeoff will be cost versus performance.

The car operating system software can do many things that a mechanical car needs special hardware to do. Electronic stability control, for example. And four-wheel drive. When the car is stopped and plugged into a charging station, the car operating system might monitor the battery, generate the charging algorithm, and control the charger.

Navigational information might also be held in and processed by car operating system to provide navigation instructions to the driver. The car operating system might also control all the auxiliary systems in the car, including lighting, de-misting, de-icing and seat heating.

The control system then generates the appropriate outputs to continuously control motor torque and speed, steering, braking, regenerative braking, external lighting, heating, ventilating and air conditioning. It also controls battery recharging and other tasks, when needed.

b. Control and Sensor Inputs

The car operating system will need sensors to tell it enough about the car's operations for the operating system to give the right signals. Things like motor, battery, car and ambient conditions, and the need for regenerative braking, headlights, heat or air conditioning. It combines this information with driver-demand inputs from braking, steering, accelerator and the various switch controls available.

Sensors have become sufficiently small, fast, and accurate to provide real-time feedback of what's happening. With truly electric cars, it becomes much easier to sense information, and to add sensors. That will allow more sophisticated safety systems to be added at a cheaper cost. Not just air bags for the front and side of a car driver or passenger, for example, but a protective shell might pop out to protect their whole body.

Information on car and battery conditions and the way the car is being driven can be generated. The driver can then know how long he or she can drive before the battery needs recharging. The driver can also be alerted to any functional problems with the car. The system can also provides the usual information for driver instruments—the car's speed, distance traveled, state of charge, miles to battery “empty,” charger in operation, and inside and outside air temperatures.

c. Data and Power Buses

Data buses carry information throughout the car. To make the car operate more reliably, four (or even more) data buses will be needed. One data bus will carry signals between the car operating system and the motors. A second will carry signals to and from the brakes and steering. A third will carry signals to and from peripheral systems like lights, windshield wipers, door locks, and windows. And a fourth will carry signals for systems like entertainment and navigation.

Existing data interfaces can be used, or new interfaces developed. Controller area networks (CAN) buses work well for some things. But they do not have the tight clocking of most other networks.

Clocked networks—like FlexRay or the Time-Triggered Protocol (TTP)—both run with a clock to trigger action. Actions happen based on priority at defined times. Actuators, motors, and all other network nodes share and use the same clock.

Other examples of bus designs, protocols, and software environments include OSEK (a German acronym for real-time executive for engine control unit software), Media-Oriented Systems Transport (MOST), and K-Line (ISO 14230).

My car will work best using several standards at once. A BMW 745i, for example, uses three:
a MOST bus for infotainment gear;
a variety of high-speed, low-speed, and fault-tolerant CAN buses for engine and other control applications; and
BMW's own ByteFlight high-speed bus (which is evolving into FlexRay) to control airbags and other systems for ensuring the safety of a car's occupants.

Power buses will carry electrical power throughout the car. An electrical power bus can convey far more power in much smaller, lighter conduits, and do it far more precisely and reliably, than even the best-designed mechanical drive train.

Indeed, on the key metrics of speed and power density, the electrical power train is about five orders of magnitude better. Electricity moves at close to the speed of light. All thermal and mechanical systems move at the speed of sound, or slower. By a very wide margin, electricity is the fastest and densest form of power that has been tamed for ubiquitous use.

With less weight in the power train, and fewer moving parts, electrical power systems are also more robust. Pneumatic and hydraulic fluids leak, turn into gel when they get cold, and are easily contaminated. Shafts, belts, and pulleys need lubricants, and get bent out of shape when they expand or contract. They corrode and need periodic maintenance. Electric wires don't.

In this design I use a system-wide 42 volts. In 1988, the Society of Automotive Engineers looked at high-voltage electrical systems in cars. They concluded that if the system voltage were kept below 65 volts, electrical contact between people and circuits need not be prevented. Looking at much of the same data, the German car standards-making body decided that the peak bus voltage should not exceed 60 volts DC, including transient voltages, without protection.

To get enough power, though, existing electric car motors typically operate at much more dangerous voltages—higher than 300 volts in many cases. In my truly electric car, the motors are designed to deliver high power at 50 volts or less, which will not cause a fatal shock even in an accident. Those lower voltages are much safer.

d. “Drive by Wire” Throttle

Conventional throttle systems have a cable running from the gas pedal through the firewall and into the throttle body. This cable slides within a housing as it winds its way around various components. That system is relatively bulky and prone to wear. It needs periodic oiling and adjustments. But it rather simply allows the driver to speed up or slow down the car.

My example of a truly electric car uses a system called “throttle by wire.” No mechanical cable connects the gas pedal to the throttle. Instead, a sensor provides pedal position (or some other input from the driver) to the car operating system. That data is combined with data from several other components. The operating system then coordinates systems such as antilock braking, traction control, four wheel drive, cruise control, and steering—in addition to the driver's signal provided by the gas pedal—to decide how much power the car's motors should provide.

I talk about the throttle here in the section about the car operating system because the throttle function is done here. But the “gas pedal” itself is part of the driver control unit. As noted below, my design makes a gas pedal unnecessary. Those who want the familiar can continue to use one. Those willing to try something new can use a joystick or steering yoke with throttle and brakes on the yoke.

2. Driver Control Unit

The car's driver uses the driver control module to drive the car. Good drive-by-wire systems have been developed that work well with a truly electric car. My design uses a steering yoke, with throttle and brake controls, as the driver control unit. There is no steering column. The driver control unit swings out from the middle of the front area of the car, so it can be used from either front seat.

Or the standard steering wheel and brake and accelerator pedals can be made electronic and used. In fact, on many of the more expensive cars, these controls already are electronic. These controls just need to be attached mechanically and plugged into a data and power bus.

Many people will prefer the traditional control design. But steering wheels are the cause of many crushing injuries sustained by drivers. The use of airbags and redesigned steering wheels has reduced the frequency and severity of such injuries. Eliminating steering wheels would remove the injuries completely. In this example of a truly electric car, a steering wheel is not needed.

Drive-by-wire's real hallmark is much better safety. In wet or icy conditions, or with the jolt of an accident, human perception and reaction are not fast or accurate enough. Computer systems can detect and react far more quickly without making the car swerve or skid.

Electronic controls improve driver control. Handheld driver controls can enhance driver feel and response, significantly reducing braking speed (a car moving at highway speeds travels more than 20 feet as the driver moves his foot from the gas to the brake). Without a steering column and pedals, the driver space becomes roomier and more comfortable. In the event of an accident, no steering column and pedals means less chance of injury or entrapment.

The “user interface” for my design is a flat-screen display that can go anywhere, and that is almost infinitely customizable. Choose from a range of speedometer styles. Swap gauges around. Display any of lots of other data—from tire pressure to instantaneous fuel economy—automatically or as needed. Select audio prompts. Program security features. Access wireless telecommunications. All these features become possible by the computer-like, software-driven, open-architecture design of the display.

3. Four In-Wheel Motors

To save on space and improve performance, in my example of a truly electric car I put the motors in the wheels. I use motors that are powerful, producing more torque per weight (more than 20 Nm/kg) and per volume than other motors. Their lower weight reduces the handling problems coming from high unsprung mass. Their smaller volume allows them to be placed within a tire's normal wheel. (Details of these motors can be found in U.S. patent application Ser. No. 10/359,293.)

System voltage for the motors is 42 volts. Current will vary up to about 80 amps. (Details can be found in U.S. patent application Ser. No. 10/736,792.) Even with these low voltages and low per phase currents, a set of four in-wheel adaptive motors can produce 68 kilowatts of power and 2600 Newton meters of peak torque, with a torque density of 21.7 Newton meters per kilogram. No existing motor technology can match that.

My example of a truly electric car tolerates faults. The car's operating system lets the car's driver “limp home” until repairs can be made by using working motors and, within a faulty motor, working phases. Often the effect of faults may not even be noticeable. Fault tolerance like this makes it unlikely that a driver will be stranded by a truly electric car that refuses to move.

Four in-wheel motors make all-wheel drive easy. When all the wheels are driven, wheel spin is minimized. When a car is stuck in deep snow or the pavement is slick, traction can be applied to the tire that has grip. The car can be better controlled, even under difficult road conditions, than with today's high-end traction control systems for normal cars.

In addition, a four-wheel drive train for a gasoline car is complex and expensive to manufacture. An electric four in-wheel drive system is simple—made just by programming a controller chip. This is “true” four wheel drive, since each wheel can be turned or stopped independent of any other wheel. Different wheels can even turn in different directions at the same time. Speed control is easy and immediate.

Eliminating any systems between the motor and the wheels can lead to maximum efficiency. In solar cars, where the very limited electrical energy makes efficiency paramount, in-wheel motors are very popular. Some have reported peak efficiency of their motors of 98%. That is hard to beat.

a. Rotor

The rotor for my motor has two belts of 18 permanent magnets each. The two belts are arranged side by side along a non-magnetic circular back plate. The magnetic polarity of the magnets in each belt alternates from north to south going around the belt. The belts lie side by side along the back plate. The magnetic polarity of each belt's magnets is offset so that a north pole in one belt lies alongside a south pole in the other belt, and vice versa.

b. Stator

The stator for my motor has 15 electromagnet pairs, with each pair arranged lengthwise around a circular central circular ring. Each electromagnetic pair is a U-shaped electromagnetic core. The two upright legs of the “U” are wound with copper wire to function as electromagnetic poles. These stator windings are switched by power electronics to form the alternating electromagnet field that forces the rotor to rotate.

Most motor makers use laminated electrical steel to make the electromagnetic cores. Complex three-dimensional shapes of the cores can be used in this motor to improve performance. To make those shapes more easily, the electromagnetic cores may be manufactured from Soft Magnetic Composite (“SMC”) powder alloys or alloyed sintered powder materials (“SPM”).

In this motor, each electromagnetic circuit, or “phase,” has been electrically separated from the others. Isolating each electromagnetic circuit gets rid of most electrical and electromagnetic interference between the circuits. That allows each phase of the motor to be carefully controlled. That lets the motor be optimized, leading to efficiencies that get closer and closer to the theoretical maximums.

c. Cooling System

Even at their most efficient, the wheel motors will generate waste heat. Cooling them with air may not work well. Oil or de-ionized water will work better. Motor cooling technology will be stretched a bit by the tight space in the wheel coupled with its exposed position. But cooling should not be too difficult for those skilled in that art.

4. Four Motor Controls

The motor control module provides the electrical signal to drive the motors. My module is software based. More than any of the other modules of the truly electric car, the motors and motor control will need to fit together well. That is, the motor control will need to provide a signal to the motor that reflects the particular architecture of the motor.

That being said, separating the motor and motor control into separate modules makes sense. Motor control technology can be based mostly on software. Mine is. (Details can be found in U.S. patent application Ser. No. 10/359,293). Motors are pure hardware. The difference in basic technology means that parallel development—with one company doing the motors and a different company doing the motor controls—may give the best results.

For an electric car to operate efficiently, all car systems must treat every amp of electrical current as precious. The amount of energy available is normally much less than in a gasoline car. But performance needs to be comparable if the electric car is to operate on the roads at the same time as gasoline cars.

My example of a truly electric car takes that control to a higher level, providing dynamic control over a range of parameters. An adaptive electric motor or generator control system provides optimal performance by dynamically adapting to changes in three things:
user inputs,
machine operating conditions, and
machine operating parameters.

This adaptive control system may also store in its memory some preset parameters for the particular machine. When changes in the above three things occur, the control system calculates the optimal waveform profile for the motor. It then drives the motor according to that profile. The cycle repeats up to thousands of times per second.

This adaptive control system takes advantage of the maximum number of independent control parameters for any given motor. That gives greater freedom to optimize. In turn, that allows motors (and generators) to perform better than bigger, heavier machines, particularly more efficiently.

Adaptive controls can also improve operation of adaptive electric motors to reduce NVH (“noise, vibration and harshness”), eliminate or reduce audible noise, control load spikes, and provide fail-safe operation. In addition, adaptive controls can be used to compensate for changes in motor operation due to wear and tear, and to reduce torque ripple and other poor motor characteristics.

The software-based nature of adaptive controls allows car designers a great deal of freedom. Designers can fully customize a unique, “differentiating feel” for their car and develop functions based on their own intellectual property.

Software code achieves that different feel. Carmakers used to need to get that “feel” from different hardware configurations—hard to do on an assembly line. Sofware “feel” makes development quicker than ever, with short turnaround, allowing faster response to changing market conditions without replacing hardware. This brings rapid development of real-time control programs and powerful cost efficiencies to product development and manufacture.

In fact, adaptive electric motor control technology may influence the whole design concept, general approach and technology of a car. With an adaptive control system comes total electric and electronic control of the car.

Eventually, all of the motor control may be implemented in software, so that the basic control algorithms can be modified by loading new or upgraded software, without replacing any hardware. If desired, this could be done remotely, such as over the Internet. In addition, fault detection and repair may be done remotely in some cases.

This adaptive motor control system can be used with almost any motor design, improving performance by improving control. But the most advantages may be gained with an adaptive electric motor, since its architecture allows for more effective control than conventional motor designs.

a. Motor Control Hardware

My motor control hardware has both computing and power electronics. A digital signal processor, with memory and support chips, can handle the computing. Sets of power electronics handle the power switching (I discuss the power electronics units separately below).

Electricity provides fast and dense power. Because of that, controlling large amounts of electrical power has been difficult. Electrical control systems tended to be erratic and inefficient, and large and expensive.

That has changed with the invention of new power semiconductors. New semiconductors can provide the extraordinarily precise control of very large amounts of electric power, at very low cost, in very compact controllers. We have long been able to shape enough watts of electrical power to run a loudspeaker, vibrating a diaphragm through a Mozart concerto. We can now do the same with a hundred kilowatts. That can run a truly electric car.

I get one big advantage in the motor control hardware by isolating the phases of my motors. That lets me run the entire car at 42 volts, and peak currents of less than 100 amps. At those voltages and currents, I can use MOSFETs instead of IGBTs.

Separately controlling each phase of the motor means I will need more controllers. That's the bad part. Being able to use the cheaper, better MOSFETs means that even with more controller, my motor control hardware will be cheaper and run cooler. That's the good part. Those advantages can be big.

b. Motor Control Software

The motor control software can perform many functions. The simplest (and cheapest) software will perform just the most basic functions—mainly making sure that the motors provide the power that the driver wants. But more sophisticated motor control software can go well beyond that.

That allows adaptive motor control. Because direct-drive power trains are informed by very fast sensors controlled by computers, they can adapt to changing conditions, reacting much faster to the outside world. Direct-drive motors can thus reach levels of precision completely unattainable with any conventional technology. Imagine trying to control a wheel with a gasoline car so that it turns only once. With an electric motor, you can control the wheel not only so it turns just once, but so it turns just a centimeter.

Motor control can be optimized for best performance even as conditions change. For example, if a car requires high torque to climb a hill at low speed, from a standing start, the motor controller may adapt to provide that. If the car needs high torque to pass on a freeway at 70 miles per hour, the motor controller may provide that.

As another example, a sine waveform profile might be used by the motor controller. A sinewave profile works nicely to extend battery life through its more efficient operation. But sinewave profiles have a problem. They limit torque. Most power supplies have a limit on current. When peak current is limited, and a sine waveform profile is used, the average current will be about ⅔ the peak current. So maximum torque will be just ⅔ of the real maximum torque.

With my motor controller, if it decides that the motor needs to put out the absolute maximum torque possible, more torque than the sine waveform profile can provide, the controller switches to a square wave profile. That profile will produce more torque than the sine waveform profile, even with a power supply with the same maximum current rating. (There is a drawback to this increased torque, though. Power loss will increase by about 40%, greatly reducing efficiency.)

A variety of other algorithms can be used in the motor controller to get the best results. For example, a motor controller might use a phase advance scheme to counter the problems caused by back EMF (electromotive force) building up at high speeds.

At least three types of algorithms come to mind:

First—performance-oriented algorithms. Here, the controllable parameters are calculated to optimize performance at given speeds and torque. The torque/efficiency optimizing and phase advance algorithms discussed above fall within this category.

Other algorithms can include measures designed to damp the vibrations or other handling problems that may be caused by bumps or other irregularities in the road surface. In fact, these algorithms can be used to counteract, at least to some degree, the effects of the unsprung mass in the wheels of the car.

This software-based, dynamic damping of the in-wheel motor drive system may result in better road-holding performance and a more comfortable ride than are possible with conventional in-wheel systems. It may offer advantages over conventional, single-motor electric cars, or even over gasoline cars, in safety and comfort.

Second—algorithms oriented toward working around faults. Here, the controllable parameters are re-calculated based on specific fault information so a given speed-torque profile may be maintained. Other desired performance characteristics can also be optimized to the extent possible.

For example, if each “phase,” or electromagnetic circuit, of the motor is independent, the motor controller can compensate for one phase going faulty. The motor will operate, but “limp along” with more torque ripple and cogging and less torque.

That kind of “limping along” fault tolerance alone may be a big advantage over other motor designs. But it gets better. With appropriate algorithms, the motor control may compensate even for these faults. It can reduce torque ripple and cogging, and increase torque from other phases to keep torque up.

Third—algorithms geared toward dealing with manufacturing tolerances and wear. These algorithms are based on the premise that each part of a motor, although manufactured to specification, may still deviate slightly from that specification. These algorithms may correct for such deviations, as well as deviations caused by wear.

c. Twenty Motor Phase Power Electronics Units

The power electronics to supply current in the needed waveform will vary according to the motor design. Ideally, each phase in the car's motors will have its own independent power supply. This further isolates the phase electronically from its neighbors. That lets the phase be controlled more tightly. And tight control means better efficiency, since optimization algorithms can be used.

In my design, each motor has five phases (with three stator poles in each phase). That means five motor phase power electronics units per motor will be needed. Each power electronics unit has a four-MOSFET bridge, with each transistor controlled by the motor control hardware and software. The transistor switches the 42-volt power that comes on a power bus from the power unit.

Each transistor switches power only off or on, with no other settings. To get the proper current waveform, the transistor will make the time the transistor stays on longer or shorter. Called “pulse width modulation,” this technique makes the power electronics simpler and, therefore, cheaper.

5. Power Unit

The power unit provides electrical power to the electric motors, and to other electric devices in the car. Electrical power is made available throughout the car by one or more power buses. The electrical power can come from a bank of batteries, or an electrical generator powered by a gasoline engine, or a combination of both, such as in a plug-in hybrid.

a. Twenty-One Battery Packs

Any electric car will need batteries (just like today's cars need a battery, only my example of a truly electric car will need more). I use 21 separate battery packs for this car. That lets me have one independent battery pack for each phase of my motors. (I have 5 phases per motor, and 4 motors, for a total of 20 battery packs for the motors.) The last battery pack is for the other electrical systems of the car.

I use nickel metal hydride batteries in this example car. Toyota has used nickel metal hydride batteries in its Prius cars for a decade. While lithium-ion batteries have some advantages, they also carry bigger risks, and performance may not be much better in the long run. Nickel metal hydride batteries have been proven to work.

b. Adaptive Generator

Any electric motor design can be used as a generator, and vice versa. My example of a truly electric car uses an adaptive generator design similar to the adaptive motors used. Each group (three stator poles in each group) of the generator's stator poles is electrically independent from the other groups. The generator's control algorithm is designed to get as much electricity as possible from mechanical motion.

c. Diesel Engine

My example of a truly electric car includes a 68-kilowatt turbocharged, direct-injection diesel engine to power the generator. Controlled by the car operating system, this engine will turn on as needed to directly provide electricity to the car's wheel motors, to recharge the car's batteries, or to do both at the same time.

Other engines can be used. Pao C. Pien designed a diesel engine that can get 60% thermal efficiency at a constant speed. (U.S. Pat. No. 6,848,416) That efficiency comes even at a temperature low enough to keep nitrous oxide pollution at a minimum.

Another choice could be a free-piston engine, which combines the engine with a generator by putting permanent magnets on the piston and surrounding the cylinders with copper wiring. That kind of engine may be able to put out 68 kilowatts at about 68 kilograms in engine weight. (See U.S. Pat. No. 6,651,599 for an example.)

d. Fuel Tank

My example of a truly electric car runs on liquid fuel—it will power a generator that provides the electricity to move the car. The big advantage of liquid fuel is the ease with which it can be pumped and stored. My car will store 10 gallons of diesel fuel (400 kilowatt hours worth) in a molded fuel tank that costs about $50. The tank can be refilled in less than 5 minutes. A battery pack to hold 400 kilowatt hours of electricity might cost $400,000. And take up to several hours, and from a regular wall socket days, to recharge.

That comparison is a little unfair. I will be lucky to get half of the energy locked into the diesel fuel out as electricity. A battery-only electric car with a 400 kilowatt hour battery pack (if there ever were such a thing) could probably go a good 2,000 miles on that charge, getting much more distance out of the energy. But the comparison does show, quite starkly, the advantages of liquid fuel over batteries in storing energy.

a. Heat for Car Interior

In my example of a truly electric car, in addition to electrical power, the power unit provides heat energy to heat the interior of the car, for passenger comfort. The heat may be waste heat (from a gasoline generator), from a propane heater (especially for heating the car interior), or even heat from electrical resistance (like an electric dryer produces). The car body module needs to have the ducting to move the heat around, but the power unit needs to provide it.

A propane-based heating system may work best for cars that need to make it through bitter winters, like those in Maine or Minnesota. The logical thing to do with electric cars is to use fuel-fired interior heaters, at least any that are used in areas with colder climates. It is typically six times more efficient to use a fuel powered heater than to idle a vehicle for heat.

My car needs about two kilowatts of heat to keep comfortably warm at around zero degrees Fahrenheit. That means 16 hrs of heat from one gallon of diesel burnt at 85% efficiency or two gallons of methanol burnt at 90% efficiency. (Methanol burns cleaner than diesel, even if it has less energy per gallon.) California cars may get by with electric heat, or perhaps waste heat from the car's motors or batteries.

6. Car Body

The car body will have the seats, the doors, the windows, the interior space—all the other things that make up most of what we think of as the car. The car body will focus on passenger safety and comfort. Attractiveness will also be a focus. Careful engineering will be needed to divide the body and chassis into separate modules, without adding too much weight and cost.

Added to weight and cost savings, my design also saves space by eliminating, down-sizing and “repackaging” vehicle systems. No central drive motor and drive train (including transmission, differential, universal joints and drive shaft) means more space to locate the power unit.

These space savings, plus the ability to locate systems (apart from the wheel/motors) anywhere in the car, give flexibility in locating important masses to improve weight distribution. That also provides improved crash zone design possibilities, additional flexibility in locating passengers and luggage, and ability to provide a more comfortable and roomy interior, such as by lowering the floor.

The frame structure can often serve double duty as a storage container for batteries and other components, reducing the weight of the body. If the heaviest components and the batteries are situated below the floor, the center of gravity becomes lower and stabilizes the car. The center of gravity can be ⅔ lower than in today's cars.

a. Car Exterior

A truly electric car (or any design for that matter) works best with a car exterior that has as little drag as possible. Gasoline cars usually depend on air flow to cool the radiator. So the car will have a drag coefficient of at least 0.20, and usually much higher. And the surface area of the car that creates drag will be fairly large.

At freeway speeds, overcoming drag requires the most power from the car. Drag increases greatly as speed increases. In fact, the force needed to counter drag grows proportionally to the cube of the speed.

The car exterior in my design will be similar to today's cars. But some experts believe that even a four-door, five-passenger sedan can be designed that has a drag coefficient as low as 0.015. That's about the same as a softball. (Of course, the surface area creating drag will be larger for a car than for a softball. So the car's drag will be much greater than the softball's, even though the drag coefficient is the same.)

Cutting the drag coefficient from about 0.35 (a normal sedan value) to closer to 0.035 (the drag coefficient of a Boeing 747 jetliner) will improve fuel efficiency at high speeds dramatically. And if surface area is also reduced, aerodynamic drag at high speeds may be reduced almost below notice. That will not be easy, of course. But it may be possible.

b. Windows and Doors

Windows and doors do not differ much from car to car in today's cars. A truly electric car may well have the same kind of windows and doors as today's cars. My design does. But there are a few areas where changes may be made.

One example has to do with the drag coefficient. No one needs to open doors, the hood, or the trunk when a car is going down the road, particularly at speeds over 40 miles per hour. That may give the opportunity to modify the shape of the car to minimize drag. When we fly on an airplane and look out the window at the airplane's wings, we see the wing change shape during takeoff and landing. Will it be worth it to do the same thing with a car? Time will tell on that question.

And if the designer of the car's body attempts to get a drag coefficient under 0.1, you may see some strange doors in your car. To minimize drag, some car bodies are lowered on the car's occupants once they are seated, and the car body is then aerodynamically sealed to the chassis.

c. Car Interior

The car's interior can be designed for three things—safety, comfort and fashion. No longer need the car interior be constrained by the car's steering wheel, engine compartment, and transmission. Interior designers may want to have a go at this. For my example of a truly electric car, I just use standard seats in a standard configuration. (My imagination does not extend to interior design.) The big change is no dashboard and no steering wheel.

d. Driver and Passenger Communication, Navigation and Entertainment

Navigation and cell phone systems have become important sales points for new cars. Entertainment has grown up from just a radio to include sophisticated and expensive sound systems, movies and video games.

A truly electric car has no problem accommodating those kind of electrical systems. With the communication and power buses of a truly electric car, those systems become much easier to install, either before the car is sold or after.

e. Heating and Cooling

Heating and cooling of the passenger compartment puts a strain on a truly electric car. Many such cars will have no big gasoline or diesel engine pumping out waste heat for the taking. And a car's air conditioner can be a real power hog when the compressor is running.

Cooling may be aided by fans and passive design of the passenger compartment to minimize the effect of the sun. For example, a car could have an electric fan on its roof that operates even when no one is in the car. That would keep the car from reaching oven temperatures, and make the air conditioning more effective when people get back in the car.

Those who live in Texas or Arizona may want to beef up their cooling systems. Others may find that they can get enough cooling from a vent to outside air and a fan.

The power unit supplies the heat to the car body. The car body needs to supply the ducts and fan to get the heat to the car's passengers.

7. Car Chassis

Different car bodies will be able to ride on the same chassis. That is, chassis designers will have complete freedom to design the chassis, according to the design rules, without being limited to a particular body.

Complete freedom may be an overstatement. The body of the car must be connected to the rest of the car, and that will cause some constraints on chassis design. But the constraints will be minimal. For example, Ford's Model T came in nine body styles—including a two-seat roadster, a four-seat touring car, a four-seat covered sedan, and a two-seat truck with a cargo box in the rear.

But all rode on the same chassis, which contained all the mechanical parts. (In 1923, the peak year of Model T production, Ford produced 2.1 million Model T chassis, a figure that would prove to be the high-water mark for car mass production that lasts even today.)

In my example of a truly electric car, the car chassis includes an electrical steering system and a braking system. These can be hydraulic systems, but in my example are electrical systems.

The car body and car chassis modules will need to work well together, with minimal noise, vibration and harshness. For that reason, some module makers will probably offer a combined car body/car chassis module to start. That will be fine with me. Whatever works best.

a. “Drive by Wire” Steering

My example of a truly electric car uses drive-by-wire steering on the two front wheels. A 42-volt steering motor sits between the two wheels, and moves the wheels right or left as controlled by the car operating system.

The driver sends a steering change signal to the car operating system. It gets data from several sources—wheel speed and slippage from the motor control, steering angle from the steering motor, yaw rate from a sensor, lateral acceleration from a sensor—and then directs the steering motor to steer the vehicle the proper amount.

Other designs can do away with steering motors. Like a tank that turns by different signals to its two treads, a truly electric cat can turn by different signals to its wheels. Wheels can even be turning in different directions to make a tight steer.

Or going in an opposite design directions, all four wheels could be steered, to get better performance.

b. “Drive by Wire” Braking

My example of a truly electric car uses drive-by-wire braking on all four wheels. The car driver inputs a brake signal. The car operating system gets data from wheel speed sensors, a steering angle sensor, and yaw rate and lateral acceleration sensors. All this sensing determines the right amount of brake to apply at each wheel. Electrical current generated by the motor—now running as a generator—goes back to the electrical power unit to charge batteries.

By using the car operating system to brake by wire, I can take anti-lock braking, traction control and stability control to the next level. As brake control strategies become more sophisticated, and use more sensor inputs, the brake system can better compensate for driver error and changing road conditions.

All kinds of electric motors can operate as generators if their control circuits are suitably designed. That makes regenerative braking possible in most electric cars. In fact, regenerative braking was used very early on in electric car history. The first time appears to have been in an electric coupe demonstrated by M. A. Darracq in Paris in 1897.

To be effective, regenerative braking must be applied over the whole range of operation of the car, and the mechanical brakes only used as a safety backup. When used under these conditions, it is essential to avoid overheating of the motor.

This brake-by-wire system can be used with adaptive cruise control to provide automatic braking if a car ahead suddenly slows or stops and the driver fails to react quickly enough. It can also be used with a crash-avoidance system that can detect objects in the road ahead, or an oncoming vehicle, and apply the brakes before the driver can react.

Regenerative braking can generate great amounts of electrical power. When a car slows from 60 miles per hour to a stop, as much as 20 kW of electricity may be generated. A standard battery cannot handle rapid recharging at this level.

That amount of electricity cannot be stored in the battery in a short period of time. In many cases, only about 10% to 15% of the electricity from sharp braking can be stored in the battery. The rest must be handled in some other way, requiring another system for the car and resulting in the waste of electrical energy.

In most cases, conventional mechanical braking must also be provided. That takes care of the situation where the motor/generator is running at low speed and is unable to generate sufficient energy to brake a car effectively. Or when a car needs to hold its position on a hill.

One might think that regenerative braking ability would allow lighter, lower-cost mechanical brakes to be used. Unfortunately, that may not be the case. The mechanical brakes must be able to stop the car if the electric propulsion system fails, or in the situations mentioned above.

Regenerative braking for many electrical propulsion systems can be complex and costly. The energy that can be recaptured may be small in some cases. That has led some designers to the conclusion that regenerative braking is not worth doing.

c. Fully Active Electronic Suspension

Passive, reactive, energy-dissipating springs and shock absorbers suspend a typical car. In my example of a truly electric car, a powerful linear motor at each wheel moves it vertically as needed to maintain traction beneath and a smooth ride above. This fully active electronic suspension can draw a lot of power from the power unit, but in short bursts.

With the right suspension structure, electrical power can sometimes be tapped from the up and down motion of the wheels. That can add to the car's efficiency.

8. Connections, or Interfaces, Between Modules

In my example of a truly electric car, each module has three different connections to at least one other module:
data
mechanical
power
   FIG. 3 shows how the seven modules of this module connect: data, mechanical and power.

Data connects over a data bus (or buses). Power connects over a power bus (or buses). Modules connect mechanically in different ways, depending on the module. The most important will be the car body's connection to the chassis. That connection will need to be secure during driving, but allow the body to be separated from the chassis to change bodies or chasses.

a. Data

Standards for data and power transfers make “mix and match” assembly feasible. Carmaker groups already promote and develop standards. Standards help any industry increase reliability while cutting cost and time to market. So the car industry has adopted new, mainly de facto standards more and more, even though cooperation between carmakers goes against their history.

My example of a truly electric car piggybacks on those standards efforts. The data interfaces between modules can follow a variety of standards, from the carmaking industry or the computer industry. Ideally, each car will have one or more multiplexed data buses running through the car. That will be simpler in design and installation than the current wiring harnesses, which tend to be as complex as a rat's nest.

FIG. 3 shows data connections between modules. That has more connections than absolutely needed, to handle a more complicated case that gives better performance. Let me give perhaps the simplest bare-bones case of data connections, as an example.

The driver control unit gets braking, steering and throttle input from the driver. In this example, the driver control unit senses driver input to the yoke 1,000 times each second and translates that into a number. Steering is from −100 (far left) to 0 (center) to 100 (far right). Braking is from 0 (none) to −100 (full brakes). Acceleration is from 0 (none) to 100 (full throttle). Direction is 1 (forward), 0 (park) or −1 (reverse).

The driver control unit sends that data to the car operating system on a data bus. The car operating system processes that data and in turn sends signals to the four motor controls (acceleration) and to the chassis (steering and brakes). The same numbers are used, and the signals are again sent 1,000 times each second.

For the simplest case, that's it. That's the data interface. Of course, even then more information will be needed. But nothing difficult for those skilled in the art.

b. Mechanical

Mechanical interfaces will be simple too, for those skilled in the art. Let's look at the simplest case there.

The driver controls are hooked onto the car body. Strategically placed holes and clamps will allow that. The wheel/motors are attached to the chassis. Standard connections can be used there (bolts and lug nuts). The car body is attached to the chassis. Matching holes, connected by bolts and nuts, will do that. The motor controls are attached to the car chassis, again using bolts and nuts. The car operating system sits in a box in the car body. All mechanical connections can easily be made by those skilled in the art.

c. Power

Compared to a gasoline car, power interfaces in a truly electric car are simple. Power buses will be best. But in the simplest case, power connections can be made using point-to-point wiring. In my example of a truly electric car, the voltage car-wide is 42 volts. Wiring and connectors can be standard. Wire thickness will depend on expected current flows. For those skilled in the art, nothing difficult about this at all.

### K. THE DRAWINGS

FIG. 1 shows a prior art electric car.

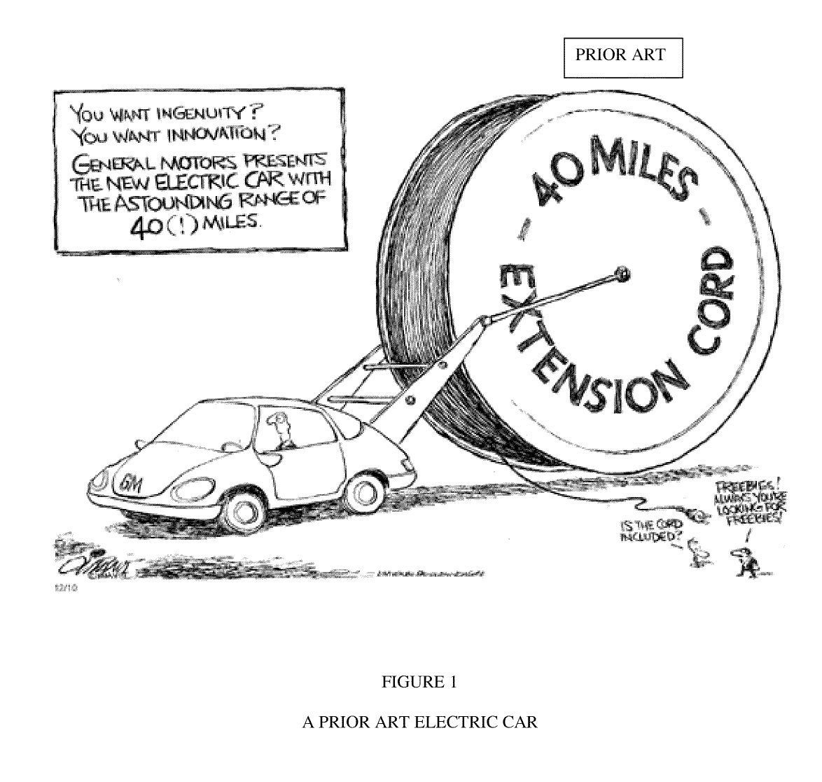

FIG. 2 shows a block diagram of an example of a truly electric car.

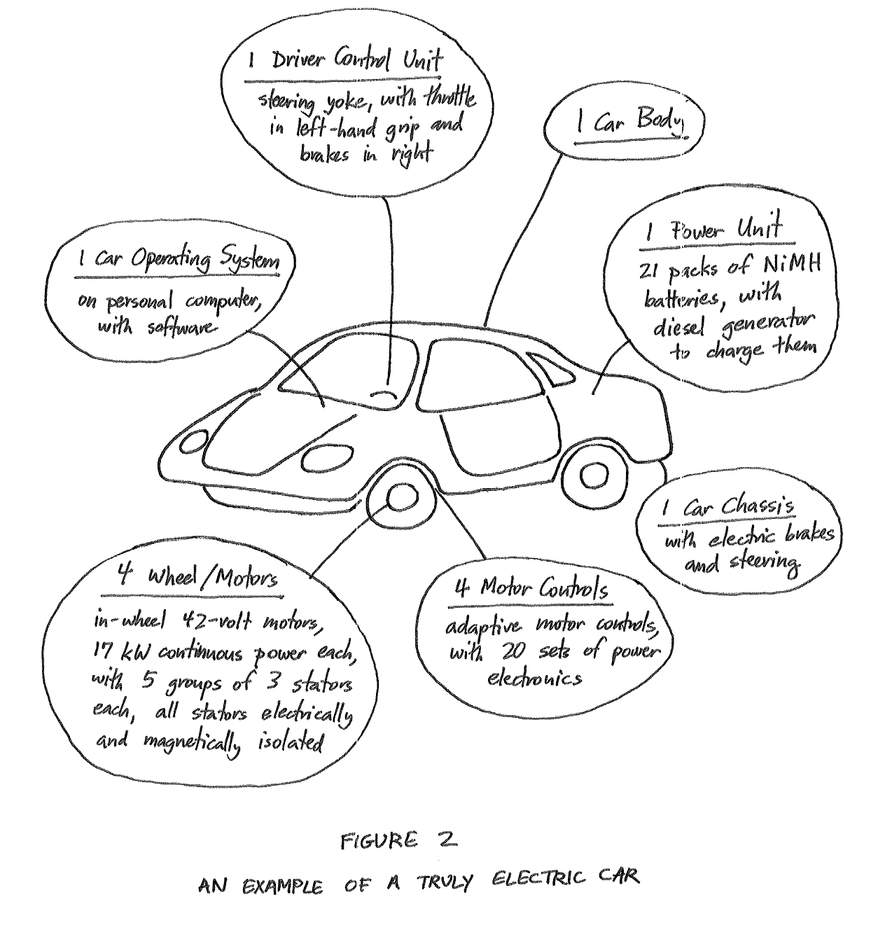

FIG. 3 shows how, unlike a gasoline car, a variety of energy sources can provide power for a truly electric car.

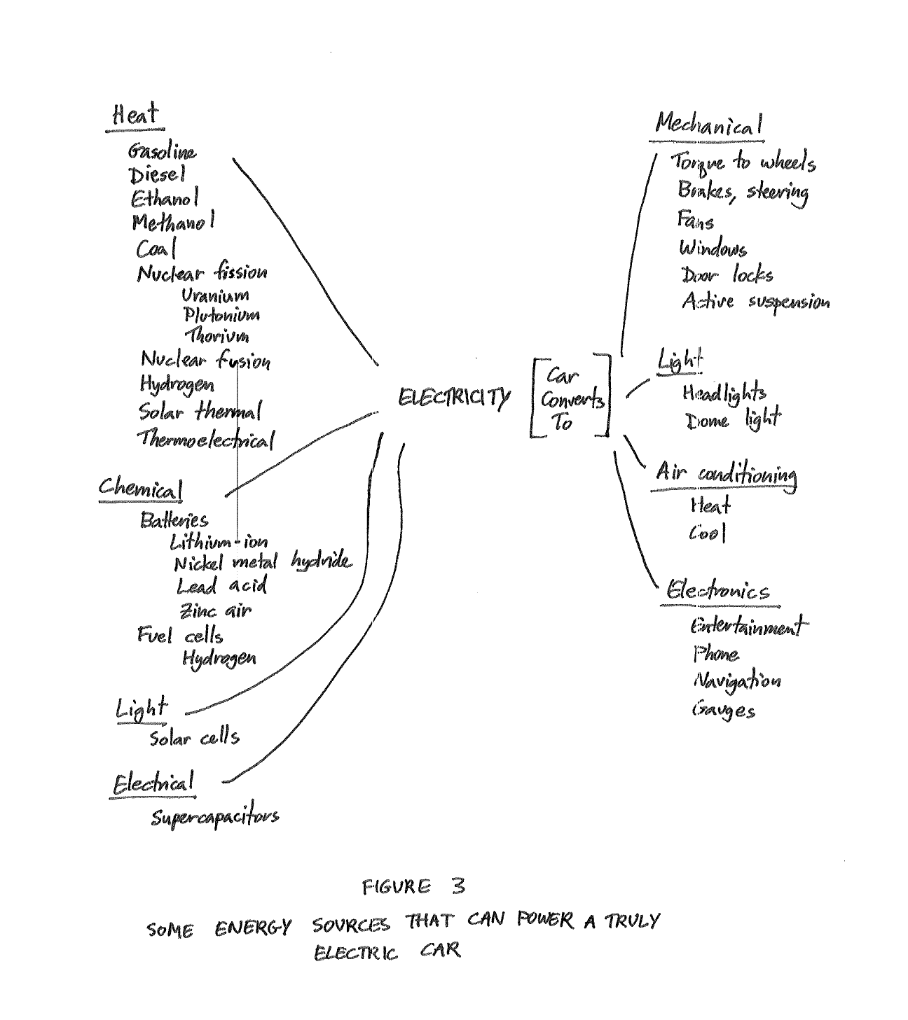

FIG. 4 shows an example of how seven modules of a truly electric car connect, for data, mechanically, and for power.

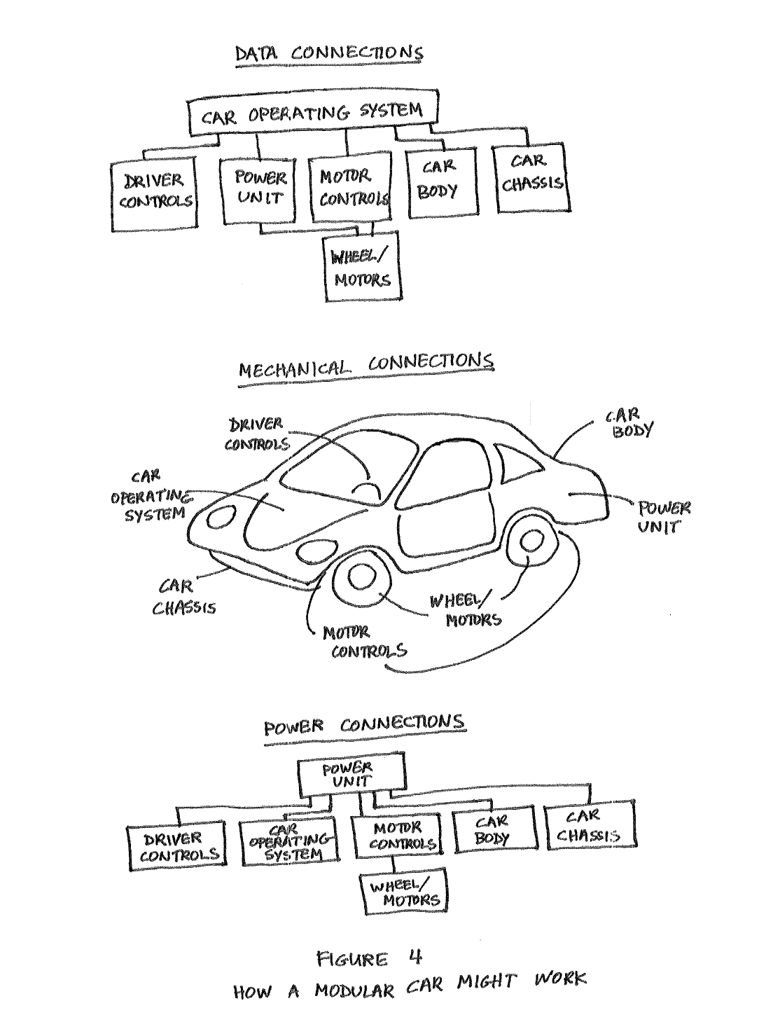

FIG. 5 shows the characteristics of a truly electric car compared to the characteristics of a gasoline car.

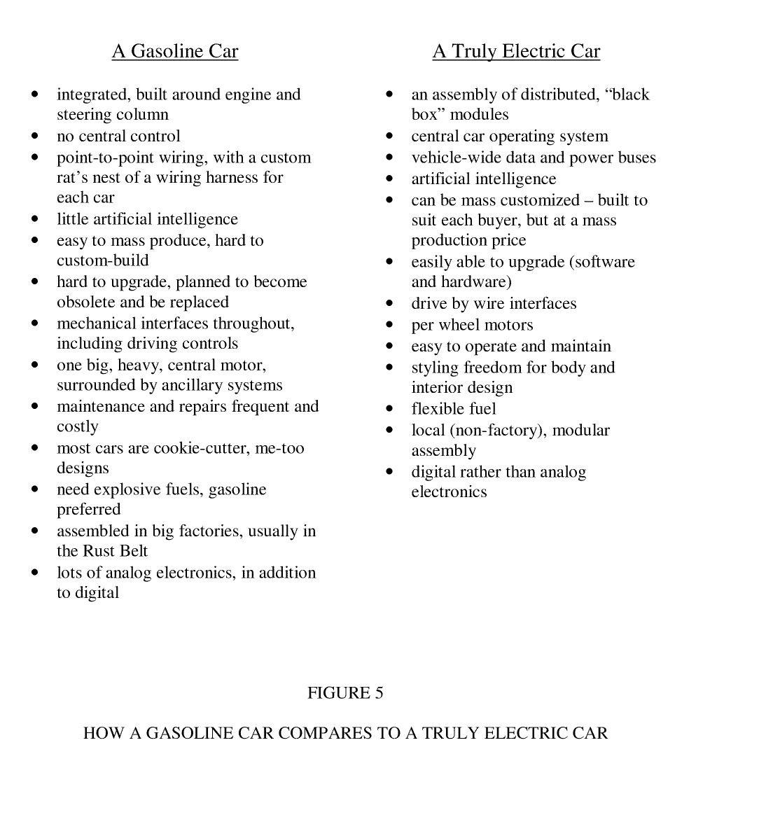

FIG. 6 shows the top-level design of an example of the operating system software for a truly electric car.

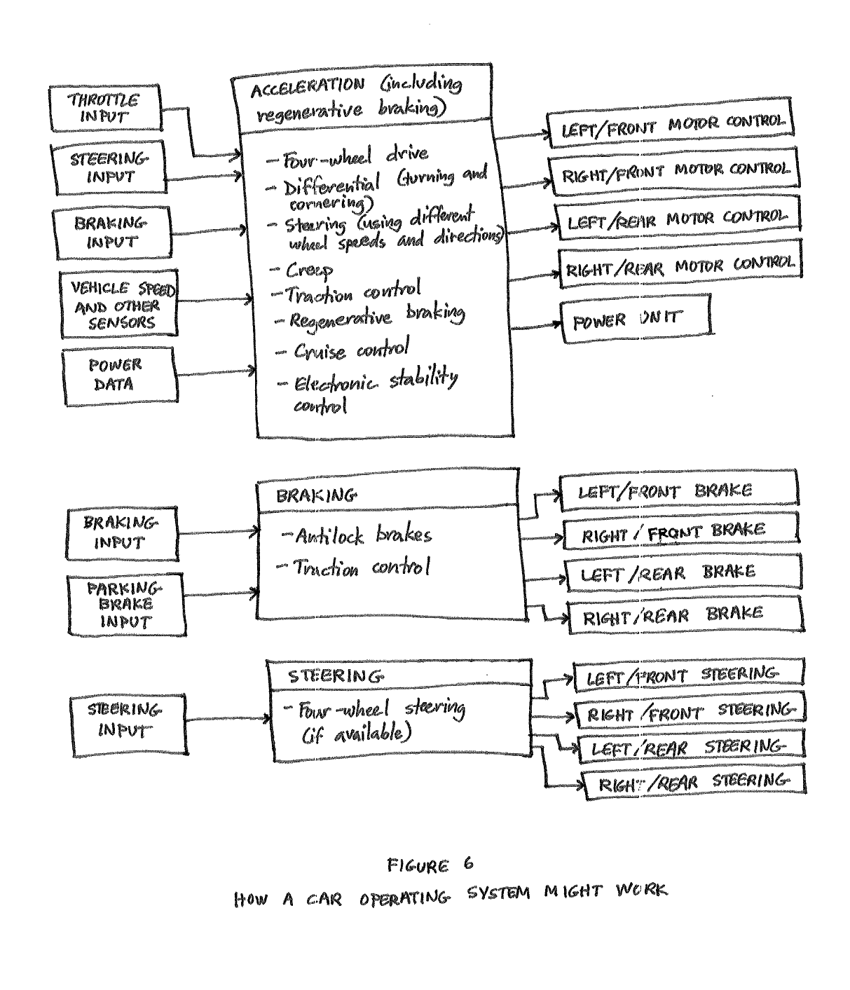

I claim:

1. A truly electric car (or other vehicle) that includes at least three black-box modules.

2. The truly electric car of claim 1 where each module has interface specifications defined for a data, mechanical and power connection to at least one other module.
